(19) United States
(12) Patent Application Publication
(10) Pub. No.: US 2025/0263555 A1
(43) Pub. Date: Aug. 21, 2025

(54) CONTROLLED LINKER LENGTH MODULATION OF DNA SCAFFOLDED DYE AGGREGATES

(71) Applicant: The Government of the United States of America, as represented by the Secretary of the Navy, Arlington, VA (US)

(72) Inventors: Adam A. Meares, Washignton, DC (US); Sara R. Ansteatt, Fairfax, VA (US); Joseph S. Melinger, Washington, DC (US); Igor L. Medintz, Washington, DC (US); Sebastian A. Diaz, Washington, DC (US); Young C. Kim, Washington, DC (US); Paul C. Cunningham, Washington, DC (US); Smriti Thomas, Washington, DC (US); Victoria Segal, Washington, DC (US); Angelica Rose Galvan, Washington, DC (US)

(21) Appl. No.: 19/058,860

(22) Filed: Feb. 20, 2025

Related U.S. Application Data
(60) Provisional application No. 63/555,424, filed on Feb. 20, 2024.

(51) Int. Cl. C09B 69/10; C09K 11/06

(52) U.S. Cl. CPC C09B 69/105; C09K 11/06; C09K 2211/145; C09K 2211/1466

(57) ABSTRACT

Described herein is the preparation of a series of Cy5 phosphoramidites whereby the linker was shortened (n=2) or lengthened (n=4) to afford aggregates of dramatically different properties despite utilizing an identical DNA Holliday Junction or DNA duplex as the scaffold. Through the use of numerous spectroscopic methods (absorption, emission, circular dichroism, transient absorption, fluorescence lifetime) and molecular dynamics simulation, it was found that when n=2, J-like aggregation is unexpectedly preferential and when n=4, H-like aggregation is preferential. The shortened linker is of particular interest as the majority of previous aggregates formed by molecular scaffolding are H-like, or mixtures of H-like and J-like components, where these constructs can exhibit nearly pure J-like behavior. Conversely, the strength of the H-like behavior can be increased with incorporation of the longer, n=4, linker.

### CROSS-REFERENCE TO RELATED APPLICATIONS

This patent application claims priority to U.S. Provisional Patent Application Ser. No. 63/555,424, filed Feb. 20, 2024; which is incorporated by reference herein in its entirety into this disclosure.

### FEDERALLY-SPONSORED RESEARCH AND DEVELOPMENT

The United States Government has ownership rights in this subject disclosure. Licensing inquiries may be directed to Office of Technology Transfer, US Naval Research Laboratory, Code 1004, Washington, DC 20375, USA; +1.202.767.7230; techtran@nrl.navy.mil, referencing NC 212526.

### INCORPORATION BY REFERENCE

This patent application incorporates by reference the Sequence Listing XML file submitted herewith via the patent office electronic filing system having the file name “212008-sequences.xml” and created on Feb. 16, 2024 with a file size of 7096 bytes.

### BACKGROUND OF THE SUBJECT DISCLOSURE

### Field of the Subject Disclosure

The present subject disclosure relates generally to DNA scaffolding. More particularly, the present subject disclosure relates to controlled linker length modulation of DNA scaffolded dye aggregates.

### Background of the Subject Disclosure

Excitonic coupling in multichromophore systems is of high interest to many applications, including light harvesting, sensing, and quantum information storage. Many approaches have been explored to afford the precise positioning and mutual orientation to achieve either H-like or J-like aggregates, ranging from the small-molecule synthesis approach (which often results in direct electronic conjugation and systems too complex to conform to traditional aggregate models) to larger scale molecular scaffolding. In an H-aggregate, molecules stack predominantly face-to-face, while J-aggregates form when molecules primarily stack in a head-to-tail arrangement. In the case of photoactive dyes, this leads to very different properties and interactions. DNA nanotechnology has been at the forefront of these efforts in recent years, as DNA scaffolds allow for the placement of species of interest with sub-nanometer precision. Indodicarbocyanines (Cy5) and structurally-similar dyes (such as Cy3 and pseudoisocyanine) have been given preference for their large molar extinction coefficients (promoting dye-dye communication), hydrophobic interactions with DNA backbones and ability to be conjugated to DNA with the proper chemical handles. For those dyes incorporated internally into DNA, it is crucial that the design possess the requisite phosphoramidite and mono- or di-methoxytrityl protected alcohol moieties. To meet this restrictive criterion, chemists have either covalently attached the dye to a modified uridine (dU) base or, more commonly, exploited a dual phosphodiester linkage. This dual phosphodiester linkage has been applied to the full gamut of cyanine dyes (Cy3, Cy3.5, Cy5 and Cy5.5) and is popular commercially, however, to date the indolenine N-alkyl substituents have been 3 carbons (n=3) in length.

A need exists for tunable linker length in cyanine dyes.

### Summary of the Subject Disclosure

The present subject disclosure relates generally to DNA scaffolding.

Described herein is the preparation of a series of Cy5 phosphoramidites whereby the linker was shortened (n=2) or lengthened (n=4) to afford aggregates of dramatically different properties despite utilizing an identical DNA Holliday Junction or DNA duplex as the scaffold. Through the use of numerous spectroscopic methods (absorption, emission, circular dichroism, transient absorption, fluorescence lifetime) and molecular dynamics simulation, it was found that when n=2, J-like aggregation is unexpectedly preferential and when n=4, H-like aggregation is preferential. The shortened linker is of particular interest as the majority of previous aggregates formed by molecular scaffolding are H-like, or mixtures of H-like and J-like components, where these shorter n=2 constructs can exhibit nearly pure J-like behavior. Conversely, the strength of the H-like behavior can be increased with incorporation of the longer, n=4, linker.

Described herein is the preparation of novel DNA-scaffolded J-like aggregates from phosphoramidites with controlled linker lengths. The phosphoramidites (herein Cy5 modified phosphoramidites) are suitable for use with automated DNA synthesis, allowing the experimenter to label DNA sequences with a wider array of linkers than what is commercially available.

Indocarbocyanines are widely used in fluorescence based biological applications such as protein and antibody labeling, flow cytometry, real-time PCR monitoring, and within FRET systems (in both roles of energy donor and energy acceptor). Several reactive moieties (succinimidyl ester, maleimide, azide) exist that enable facile conjugation of dyes or other molecules post DNA synthesis, however, these generally feature linkers of excessive length, and provide little to no control over precise placement of the conjugated molecule. The most commonly utilized method for internally labeling/conjugating a molecule of interest to DNA requires that the molecule possess the pre-requisite phosphoramidite moiety, an alcohol protected by di- or mono-methoxy trityl and be capable of surviving the overall automated DNA synthesis process. Such an approach is taken in the case of commercially available dye phosphoramidites (Cy3, Cy3.5, Cy5, Cy5.5), and for these species in particular, it is not believed that deviation has previously been made from the standard linker length of n=3 carbon atoms.

The incorporation of DNA sequences labeled with variable linker (with two, three, or four carbons) phosphoramidites into larger DNA scaffolds, provides H-like or J-like aggregate properties, based or arising from the selected linker present. This provides a unique method for selecting photophysical properties that best suit the target application, allowing one better selection over commercially available derivatives. It is believed that this is the first successful approach in achieving almost exclusive J-like aggregate behavior (as opposed to H-like or mixture of H-like and J-like aggregates) within DNA Holliday Junction scaffolds. Due to the nature of this modification, it is potentially suitable for application on other molecules, including but not limited to other indocyanine-type dies (e.g., Cy3, Cy3.5, Cy5.5).

Table 1 shows the individual DNA sequences used to prepare scaffolds.

TABLE 1

| Designation | Oligonucleotide sequence (5′-3′) |
|---|---|
| HJA (SEQ ID No: 1) | ATATAATCGCTCG-X-CATATTATGACTG |
| HJB (SEQ ID No: 2) | CAGTCATAATATG-X-TGGAATGTGAGTG |
| HJC (SEQ ID No: 3) | CACTCACATTCCA-X-CTCAACACCACAA |
| HJD (SEQ ID No: 4) | TTGTGGTGTTGAG-X-CGAGCGATTATAT |
| HJAcomp (SEQ ID No: 5) | CAGTCATAATATG-X-CGAGCGATTATAT |

Individual DNA sequences utilized to prepare scaffolds. A, T, C, and G are the naturally occurring nucleotides while X denotes site of Cy5 analog incorporation.

In a first embodiment, a variable linker phosphoramidite comprises a structure as depicted in FIG. 1A.

In a second embodiment, a method of preparing a phosphoramidite comprises a synthetic scheme as depicted in FIG. 1C.

Further embodiments include either of the previous embodiments wherein n=2 or 4.

### BRIEF DESCRIPTION OF THE DRAWINGS

The patent or application file may contain at least one drawing executed in color. Copies of this patent or patent application publication with color drawing(s) will be provided by the Office upon request and payment of the necessary fee.

FIG. 1A depicts a two-point phosphodiester linkage of Cy5 within DNA sequence (where n=2 or 4).

FIG. 1B provides a generalized schematic representation of DNA scaffolds labeled with dye: four possible adjacent Cy5 dimers on a DNA HJ, a Cy5 tetramer on a DNA HJ, and a Cy5 dimer on dsDNA. In the case of Holliday Junctions (HJ), letters A-D indicate the labeled sequences in given scaffold.

FIG. 1C illustrates a synthetic scheme for preparation of variable linker Cy5-phosphoramidites. Cy3 and other dyes can be prepared in a similar manner.

FIG. 2 provides absorption spectra for single strand (ss) DNA sequences containing variable linker Cy5s. All spectra acquired in 1×TAE 15 mM MgCl₂ buffer at 1 μM concentration of sequence. Top) Cy5-2′ labeled sequences. Bottom) Cy5-4′ labeled sequences. Sequence ssA (black), ssB (red), ssC (blue), ssD (green), ssAcomp (gold).

FIG. 3 shows steady-state photophysical properties for representative Holliday Junction Adjacent Dimer HJ-BC. Absorption (bottom), circular dichroism (CD, center) and emission (top) spectra for HJ-BC-2′ (solid, black), HJ-BC-3′(solid, red) and HJ-BC-4′ (solid, blue) in comparison to mono labeled HJ-B-2′ (black, dashed). Demonstrating increasing J-like absorbance and emission intensity as linker decreases. Presence of CD suggests presence of aggregate, as opposed to monomer. All present data acquired in 1×TAE 15 mM MgCl₂ buffer.

FIG. 4 shows steady-state photophysical properties for Holliday Junction Tetramers. Absorption (bottom), circular dichroism (center) and emission (top) spectra for tetramers HJ-ABCD-2′ (black),-3′ (red) and 4′ (blue). Demonstrating increasing H-like absorbance and decreasing emission intensity as linker increases to n=4. Presence of CD suggests presence of aggregate, as opposed to monomer. All present data acquired in 1× TAE 15 mM MgCl₂ buffer.

FIG. 5 shows normalized absorbance and CD spectra for 0 basepair separation dye-labeled DNA duplexes. Normalized absorption (bottom) and circular dichroism (top) for dimers with 0 basepair separation between dyes. Dimers indicated by the variable linker Cy5 they are labeled with, 2C (Cy5-2′, solid, black), 3C (Cy5-3′, solid, red) and 4C (Cy5-4′, solid, blue) in comparison to select mono labeled Cy5-2′ sequence, 2C monomer (ssA-2′, black, dashed). All data acquired in 1×TAE 15 mM MgCl₂ buffer and where applicable, normalized against the wavelength of maximum absorbance in the Cy5 region. Here, 2′, 3′, and 4′ refer to the number of carbons on the linker or linker length.

FIGS. 6A and 6B provide comparison of fluorescence of Cy5-2′ monomer vs dimers on both HJ and dsDNA. Normalized emission for select monomers and dimers on HJ scaffold (left) or dsDNA (right). Monolabeled species (HJ-B-2′ and HJA-2′) indicated by black, dashed lines, while dilabeled species (HJ-BC-2′ and HJA/HJAcomp-2′) indicated by red, solid lines. All data acquired in 1×TAE 15 mM MgCl₂ buffer and normalized upon wavelength of maximum emission.

FIG. 7 shows photo-selective transient-absorption spectra for representative Holliday Junction Adjacent Dimer HJ-BC. Photo-selective TA spectra for Cy5-nC adjacent BC dimers on a DNA HJ at 1 picosecond after excitation with a 100 femtosecond laser pulse. Sample in 1×TAE 15 mM MgCl₂ buffer. Top: Cy5-2′. Middle: Cy5-3′. Bottom: Cy5-4′. Insets: The pump wavelength is color matched with TA spectrum. The blue curves are difference TA spectra generated by subtracting the TA spectrum from the 662 nm pump from the TA spectrum from the 606 nm pump. 2′, 3′, and 4′ refer to the number of carbons on the linker or linker length.

FIG. 8 provides free energy landscapes of 0 basepair dimers containing cyanines of varying linker lengths (n=1-6). Free energy landscapes depict increasing J-like character when approaching n=1, and increasing H-like character when approaching n=6, for Cy5 0 basepair dimers on DNA duplex with variable linker lengths (n). In all cases the 0 basepair dimer is composed of sequences ssA and ssAcomp.

FIGS. 9A-C are a schematic representations of variable length Cy5 linkers, DNA scaffolds, and electronic transitions within the molecular exciton model.

FIG. 9A shows a two-point attachment of Cy5 to DNA using variable length linkers.

FIG. 9B shows schematics of an unlabeled DNA-HJ (top left, black), a dimer on dsDNA (bottom left, purple), and adjacent and transverse dimers on DNA-HJs (right, teal).

FIG. 9C shows a schematic of the transition dipole moment (TDM) alignments and splitting of the energy levels in the dimers.

FIGS. 10A-D shows Linker-length dependence of absorption and CD spectra for Cy5-n′ dimers. A) Absorption and B) CD spectra of ds-AAc-n′. C) Absorption and D) CD spectra of HJ-BC-n′. A reference monomer absorption spectrum is included containing Cy5-2′ on dsDNA or Cy5-3′ on HJ-B (green, dotted lines), with λₘₐₓ indicated by the dashed grey line.

FIGS. 11A-D show Fluorescence spectra of Cy5-2′ dimers on dsDNA and DNA-HJs. Left panels: Normalized fluorescence emission spectra of monomer (black, dash-dotted) and dimers (red, solid) on A) dsDNA and B) HJ-BC, respectively. Right panels: Dimer normalized absorption (black, dashed-dotted) and normalized fluorescence excitation (red) spectra for C) ds-AAc-2′ and D) HJ-BC-2′, respectively.

FIGS. 12A-F shows Photo-selective TA spectra at a 1 ps probe pulse delay time from the pump pulse. Top panel: ds-AAc-n′ dimers. (12A) n′=2, (12B) n′=3, (12C) n′=4. Bottom panel: HJ-BC-n′ adjacent dimers. (12D) n′=2, (12E) n′=3, (12F) n′=4. Red lines correspond to selective excitation of J-like dimers at 662 or 665 nm, Blue lines correspond to selective excitation of H-like dimers. Black lines correspond to the difference between blue-pumped TA spectra and red-pumped TA spectra.

FIGS. 13A-D shows Free energy heat maps for Cy5-n′ dimers on dsDNA calculated by umbrella sampling. The heat map colors indicate the free energy in kcal/mol associated with a particular dye separation, R, and orientation factor, κ. Dark blue represents the lowest free energies. The red/blue dotted ovals indicate regions where J-like and H-like geometries occur with the lowest free energies. (13A) Free Cy5 dimer. (13B) Cy5-2′ dimer. (¹³C ) Cy5-3′ dimer. (13D) Cy5-4′ dimer. Above: Representative dimer geometries for the free Cy5 dimer and Cy5-n′ J-like dimers, with (α_{m,n,MD}) as defined in the main text.

### DETAILED DESCRIPTION OF THE SUBJECT DISCLOSURE

The present subject disclosure addresses the shortcomings of conventional DNA scaffolding, as discussed above.

### Definitions

Before describing the present subject disclosure in detail, it is to be understood that the terminology used in the specification is for the purpose of describing particular embodiments, and is not necessarily intended to be limiting. Although many methods, structures and materials similar, modified, or equivalent to those described herein can be used in the practice of the present subject disclosure without undue experimentation, the preferred methods, structures and materials are described herein. In describing and claiming the present subject disclosure, the following terminology will be used in accordance with the definitions set out below.

As used herein, the singular forms “a”, “an,” and “the” do not preclude plural referents, unless the content clearly dictates otherwise.

As used herein, the term “and/or” includes any and all combinations of one or more of the associated listed items.

As used herein, the term “about” when used in conjunction with a stated numerical value or range denotes somewhat more or somewhat less than the stated value or range, to within a range of +10% of that stated.

### Overview

In recent years, DNA scaffolds have been utilized to control the positioning of two or more dye molecules, in the attempt to dictate the exciton delocalization properties and harness them for photonics applications. While the spatial separation of dyes can be controlled with sub-nanometer accuracy, controlling the relative orientation of the dyes in an aggregate has proven challenging. As part of an effort to develop next-generation molecular materials suitable for light harvesting, biosensing, and quantum information science, we investigate varying the length of the two-point linker between indodicarbocyanine (Cy5) dyes and the DNA template as a method to better control the resulting dimer geometry. To systematically test this approach, we can, for example, chemically synthesize Cy5 with either 2-carbon (2C) or 4-carbon (4C) two-point linkers and compare their behavior to commercially available Cy5 with 3-carbon (3C) two-point linkers. Using steady-state and ultrafast spectroscopy, and molecular dynamics simulations, we demonstrate that shortening the linker from 3C to 2C limits the TT-TT interactions between dyes, thereby promoting the formation of J-like Cy5 dimers. Conversely, increasing the linker length provides the dye more freedom of motion, allowing greater IT-TT interactions, and yielding dimers with greater H-like character. Furthermore, we show that the short two-carbon linker greatly reduces the orientational heterogeneity that often occurs in DNA-templated cyanine dye dimers. These results emphasize the importance of the dye linker chemistry in determining the optical and photophysical properties of DNA-scaffolded dye aggregates. They also suggest that tuning the length of the dye linker is an effective strategy to overcome two challenges that currently limit DNA-scaffolded dye aggregates in photonics applications: gaining control of dye aggregate geometry and producing homogeneous ensembles of dye aggregates.

### 1. Introduction

Programmable DNA nanotechnology¹ utilizes DNA scaffolds to assemble structures of arbitrary complexity that can purposefully position dyes and dye aggregates with nanoscale precision to engineer photophysical responses and control energy flow.^{2, 3} However, to date, control of dye orientation has remained a significant challenge for DNA-organized dye systems.⁴ Due to the extended TT-conjugation of most organic dyes, H-like aggregates with co-facial packing arrangements often self-assemble, but purposefully promoting J-like aggregate formation with an end-to-end configuration, important for promoting emissive aggregates, or oblique-like aggregate formation with a 90° orientation between dyes, important for measuring electronic quantum beats, is more difficult. A second challenge is that dye aggregates on DNA often show significant heterogeneity, where ensembles are composed of a mixture of H-like and J-like species with very different photophysical properties and are typically plagued by fluorescence quenching. These hurdles have slowed progress towards applications such as synthetic light harvesting⁵, biosensing⁶, and classical^{7, 8} and quantum information processing based on molecular excitonic circuits.^{9, 10} Addressing these two challenges is the primary focus of this work.

Controlling the orientation of a dye aggregate covalently attached to DNA requires balancing the interactions between the individual dye molecules and between the dyes and the DNA scaffold. Relevant to this goal, there have been several studies aimed at improving the orientational control of dyes covalently attached to DNA. Kato et al. showed that small planar aromatic dyes covalently attached to the DNA backbone can intercalate and align with the twist of the base stack, resulting in a fixed twist angle between dyes that depends on their separation along the DNA.¹¹ Mathur et al.⁴ and Hübner et al.¹² explored the extent to which a large DNA origami scaffold can constrain the orientation of individual dye molecules. These initial works found that the degree of constraint depends on both the local environment surrounding the dye attachment site and the type of the dye linker. Building on this work, several groups have shown that the orientation of cyanine dyes can be controlled by modulating the local strain of the DNA in the vicinity of the dye.¹³⁻¹⁶ In a different approach, Diaz et al. used chemical substituents added to the 5- and 5′-positions of Cy5 in order to exploit hydrophobicity and steric effects to influence the orientation of Cy5 dimers when templated on DNA Holliday junction (DNA-HJ) scaffolds.¹⁷ However, in many cases, significant orientational heterogeneity remained as well as highly quenched fluorescence.^{17, 18}

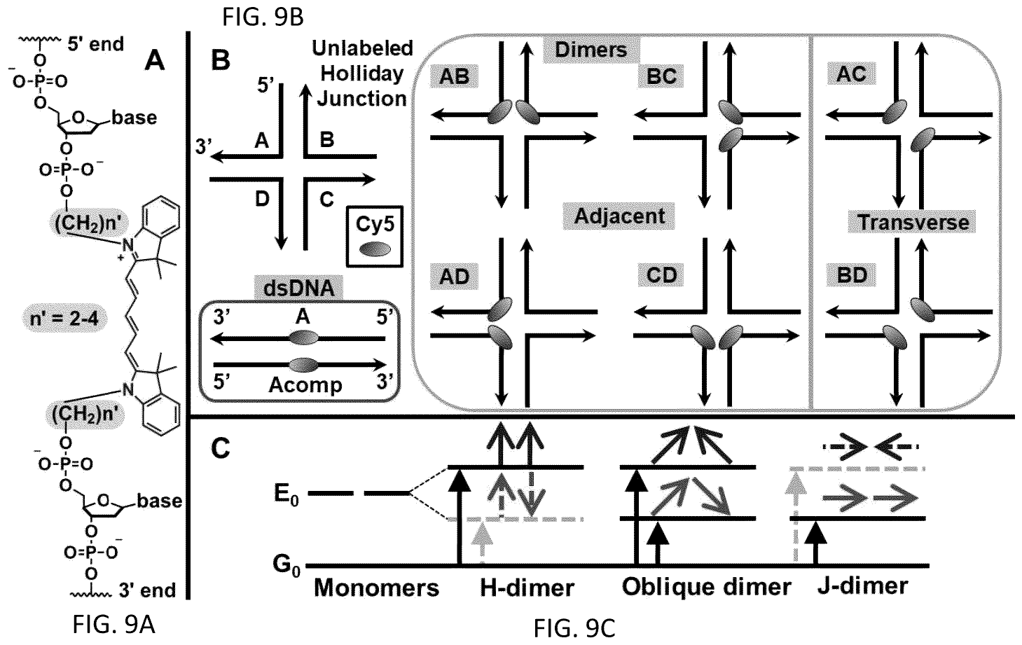

In ideal H-aggregates, the lowest energy level of the excited state is optically forbidden, leading to slow subradiant fluorescence that is often outcompeted by non-radiative processes that diminish the quantum yield. Conversely, J-aggregates are characterized by increased oscillator strength in the lowest excited state, leading to increased absorption and fast superradiant emission that can outcompete loss channels. While H-like aggregates have unique niches of application,^{6, 19} photonic systems that require ultrafast energy transfer benefit from J-like aggregates.²⁰ As such, an approach that would direct dyes attached to DNA closer to an end-to-end alignment of transition dipole moments (TDMs) is highly sought. We surmised that modulating the properties of the chemical linker that attaches the dye to DNA may be an effective approach, though such an approach has not yet been tested in the context of controlling dye aggregate orientation. We hypothesized that short dye-to-DNA linkers that limit a dye's degrees of freedom will inhibit the tendency of Cy5 pairs to form H-like packing from TT-stacking interactions, and instead promote the formation of J-like packing with a geometry that is closer to an end-to-end configuration. Conversely, longer dye linkers that allow the dye pairs greater freedom to maximize TT-orbital overlap will favor H-like packing. To test this hypothesis, we synthesize Cy5 derivatives suitable for two-point phosphodiester linkage to DNA in order to systematically vary the linker length by changing the number (n′=2, 3, 4) of carbon atoms between the Cy5 and the phosphodiester (FIG. 9A). We assemble DNA-scaffolded dimers and examine their properties using steady-state and time-resolved spectroscopy. While Cy5 dimers on double stranded DNA (dsDNA) serve as the primary system for our analysis, Cy5 dimers attached to DNA Holliday junctions (DNA-HJs) (FIG. 9B) provide additional physical insight and generalize our study to more complex DNA scaffolds.

In this work, we demonstrate that the length of the chemical linker can be used to purposefully control indodicarbocyanine (Cy5) dye dimer orientation on DNA scaffolds. In particular, our experiments show that a short linker can promote the formation of J-like dimers on DNA. Furthermore, we show that a short linker suppresses the orientational heterogeneity that typically results in a mixture of J-like, oblique, and H-like dimer geometries on DNA scaffolds (FIG. 9C).^{17, 18, 21} We use molecular dynamics simulations to provide physical insight into the suppression of orientational heterogeneity in the case of a short linker. The increased homogeneity is accompanied by an increase in fluorescence and excited state lifetime, which we suggest may arise from suppression of collisional quenching. Overall, these results lead to confirmation of our hypothesis and the purposeful construction of J-like dimers, which are highly desirable for strong light absorption, coherent exciton delocalization, and, potentially, for efficient cooperative emission. The insight that linker length can be used to influence aggregate formation by either restricting accessible free volume or allowing cofacial dye stacking is likely general to other aromatic dye systems. We view this work as a significant advance in molecular control using DNA nanotechnology, which may allow for highly efficient exciton transmission lines, excitonic transistors, and excitonic gates for quantum information science.^{9, 10}

### 2. Molecular Design and Structure Assembly

Our focus here is the modification of standard Cy5 dye phosphoramidite chemistry²²⁻²⁴ to elicit new photophysical properties when covalently attached to DNA scaffolds. The commercial Cy5 phosphoramidites feature bare (nonfunctionalized) indoles and the DNA attachment sites are via two, three-carbon long N-alkyl moieties. Cyanine dyes that are incorporated into DNA with the standard 3-carbon linker (Cy5-3′) tend to produce primarily H-like or oblique dimers within HJs, as opposed to distributions of conformers with monomer-like properties.^{15, 17, 21, 25-28} This suggests that these linkers are short enough to limit conformational variability, due to both moderate length and the nature of the two-point insertion motif, yet are long enough to permit significant TT-stacking interactions that dictate the mutual orientation of these cyanine dyes.^{29, 30} Therefore, we seek to determine how either decreasing or increasing the linker length affects the final dye-dye interactions, and, particularly, if we can achieve more J-like dimer behavior. To that end, we prepared two new dye-phosphoramidites with linkers of 2-carbon (Cy5-2′) and 4-carbon (Cy5-4′) lengths, respectively. FIG. 9A demonstrates their structure, upon incorporation into a DNA sequence. For the shorter chain, we opted for two, rather than one carbon, because we suspected that an extremely short linker (1 carbon) would result in poor yields during DNA synthesis. For the longer chain, we opted only for four carbons, because we surmised that longer chain lengths might provide too much freedom of movement, and render the DNA scaffold ineffective. Importantly, because the linker modifications do not significantly alter the electron system of the Cy5 core, altering linker length should not change the electronic properties of the Cy5 itself. The synthetic scheme for precursors and all details regarding the synthesis of active phosphoramidites Cy5-2′ and Cy5-4′ (General Procedure for Cy5-Phosphoramidite Synthesis) can be found in the SI.

FIG. 9 presents a schematic representations of variable length Cy5 linkers, DNA scaffolds, and electronic transitions within the molecular exciton model. (A) Two-point attachment of Cy5 to DNA using variable length linkers. (B) Schematics of an unlabeled DNA-HJ (top left, black), a dimer on dsDNA (bottom left, purple), and adjacent and transverse dimers on DNA-HJs (right, teal). (C) Schematic of the transition dipole moment (TDM) alignments and splitting of the energy levels in the dimers. The upward arrows indicate absorptive transitions from the ground state, where a solid black arrow indicates an allowed electronic transition, and a dashed light gray arrow indicates a forbidden transition. Blue or red arrows represent the TDM alignment and the spectral shift (hypsochromic/blue or bathochromic/red) relative to monomers and indicate if the given orientation corresponds to allowed (solid) and forbidden (dashed) transitions.

Immediately upon their preparation, phosphoramidites Cy5-2′ and Cy5-4′ were utilized in the synthesis of five unique DNA oligonucleotide sequences: strand A and its complement Acomp (or Ac) generate the dsDNA template, while four component strands (sequences A-D) comprise the DNA-HJ when hybridized together. In each of these strands, the Cy5 is centrally located. The full sequence of each 26-mer oligonucleotide is provided in Table 2. The complete details regarding DNA synthesis, purification of Cy5-labeled oligonucleotides and their yields are described in the SI. Details of the DNA assembly and the solvent conditions are given in the Methods section below. In previous works, we have found that the formation efficiency of Cy5 dimers on dsDNA and DNA-HJs to be greater than 90% and 85%, respectively ^{17, 31, 32}

TABLE 2
DNA sequences utilized in this study.

| Designation | Oligonucleotide sequence (5′-3′) |
|---|---|
| A | ATATAATCGCTCG-X-CATATTATGACTG |
| B | CAGTCATAATATG-X-TGGAATGTGAGTG |
| C | CACTCACATTCCA-X-CTCAACACCACAA |
| D | TTGTGGTGTTGAG-X-CGAGCGATTATAT |
| Acomp | CAGTCATAATATG-X-CGAGCGATTATAT |

All oligonucleotides used in this study are 26-mers with respect to number of nucleotides. X denotes the site of Cy5 incorporation, unlabeled sequences are identical to corresponding labeled sequences, with the omission of X.

The various dsDNA and DNA-HJs prepared in this study are represented in FIG. 9B. For simplicity, the nomenclature going forward will indicate the construct type-dye labeled sequences- and the linker length of Cy5 used in the assembly. It is implied that all unlabeled complements necessary for the construct are also present. For example, a mono-labeled DNA duplex containing Cy5-2′ on sequence A would be ds-A-2′ and the analogous di-labeled construct would be ds-AAc-2′. Similarly, HJ-AB-2′ indicates that the given Holliday Junction is labeled on strands A and B, with Cy5-2′. For DNA-HJs, there are two conformations which describe the locations of the Cy5s relative to each other, either adjacent or transverse. In the adjacent conformations (HJ-AB, HJ-BC, HJ-CD, and HJ-AD), the dyes are sited at adjacent position at the core of the DNA-HJ, whereas for transverse conformations (HJ-AC and HJ-BD), the dyes are sited at opposite positions at the core of the DNA-HJ (FIG. 9B). The assemblies prepared herein represent the full range of mono-labeled (monomers) and di-labeled (dimers) constructs.

Excitonically coupled dimers are often categorized by their geometry as follows: J-like, H-like or oblique (FIG. 9C), all of which possess unique optical properties from that of the parent monomer due to absorption band splitting and redistribution of oscillator strength.³³⁻³⁷ J-dimers are observed when the transition dipole moments (TDMs) of dyes, assumed here to be along the dye's long axis, align collinearly end-to-end.^{34, 35} In this case, only the lower energy optical transition is allowed and manifests as a characteristic bathochromic (red) shift of the absorption spectrum relative to the parent monomer. H-dimers are observed when dye species stack co-facially causing the TDMs to be parallel or anti-parallel to one another. In this scenario, only the higher energy optical transition is allowed and produces a hypsochromic (blue) shift of absorption spectrum. Typically, oscillator strength is also redistributed into even higher energy vibronic transitions. Oblique dimers are the broad category where the mutual TDM alignments fall between the distinct H- or J-like orientations. In such dimers, both the higher and lower energy transitions are allowed, resulting in observable Davydov splitting in the absorption spectrum.³³

For simplicity, we will use the following descriptions of dimer geometry to facilitate our discussion. We use the term J-like dimers to refer to J favoring dimers that have relatively large angles, α_{m,n}>90 degrees, between TDMs for dyes m and n, respectively, and where the strongest absorption transition is at a lower energy than the 0-0 monomer transition. We use the term H-like dimers to mean H favoring dimers that have relatively small angles, α_{m,n}><90 degrees, between TDMs, and where the strongest absorption transition is at a higher energy than the 0-0 monomer transition. This implies that the broad case of oblique dimers will be considered as J-like for a_{m,n}>90 degrees, or H-like for α_{m,n}<90 degrees.

### 3. Results and Discussion

Steady State Optical Spectroscopy of Cy5 monomer species. The linker length did not influence the photophysical properties of the Cy5 parent dyes. The absorption (λₘₐₓ=642 nm) and fluorescence (λₘₐₓ=663 nm) spectra of the Cy5-2′ and Cy5-4′ parent dyes in methanol were found to be superimposable and fluorescence quantum yields (ϕ_{F}) (0.29 and 0.30, respectively) were effectively identical. Similarly, the optical properties of the Cy5-n′ (n′=2, 3, 4) labeled onto single stranded (ss) DNA are quite uniform throughout all sequence/dye permutations, as expected. Absorption spectra show a sum of the DNA and dye absorption features, with no significant coupling between Cy5 and nucleobases. There is a minor redshift of the maximum absorption wavelength (λₘₐₓ) relative to the parent, which results from solvatochromism, the incorporation of the dye into DNA, or both, and is consistent with previous reports of dye-labeled ssDNA.³⁸ Fluorescence maxima are similarly shifted and there is a small enhancement to ϕ_{F}, which results from the increased rigidity of Cy5 when on DNA The ranges of these values are reported in Table 3, and more detailed values can be found in the SI. Taken collectively, these observations affirm that the length of the linker does not influence the photophysical properties of Cy5.

We also evaluated the optical properties of single dye labeled Cy5 monomers (i.e., a single dye present) on dsDNA and DNA-HJs. The average absorption and fluorescence maxima, as well as the OF, are compared to those of Cy5 on ssDNA in Table 3; individual spectra and tables with all experimentally determined values can be found in Section 1 of the SI. Generally, the absorption spectra across all assemblies are similar to that of ssDNA. The dsDNA monomers did not exhibit sequence dependent properties; both ds-A-n′ and ds-Ac-n′ manifest identical absorption and fluorescence maxima, as well as ϕ_{F}. Also, the linker length did not impart significantly different properties; the absorption and fluorescence peak position (λₘₐₓ) for all dsDNA monomers match within +1 nm, with a small (15%) decrease to ϕ_{F} as linker length increases from n′=2′ to n′=4′. In contrast, HJ monomers exhibited a 2-7 nm redshift of the peak absorption and fluorescence relative to the parent ssDNA. The only exception to this is HJ-D-2′, which retains identical λₘₐₓ of 647 nm to ss-D-2′. This suggests that the local environment (neighboring nucleobases) may influence the optical properties of the DNA HJs, reinforcing the need to examine all permutations of adjacent and transverse dimers. Consistent with our earlier studies, the assembly of dye-labeled DNA into a larger scaffold maintains or slightly enhances the ϕ_{F} of the Cy5, though there is noticeable variability depending on the sequence of dye insertion.^{17, 39} For Cy5-2′ on dsDNA and DNA-HJs, a possible explanation for their slightly higher Or's is suppression of torsional motion about the Cy5 methine bridge by the shorter linker.

TABLE 3
Average photophysical properties of parent
ssDNA, dsDNA, and DNA-HJ monomers.

| | | Average | |
|---|---|---|---|
| | Average | Fluorescence | |
| ssDNA or | Absorptionλₘₐₓ | λₘₐₓ (range) | |
| monomer | (range) [nm] | [nm] | ϕ_{F} |
| ss-X-2′ | 647 (645-650) | 668 (667-669) | 0.35 ± 0.04 |
| ss-X-3′ | 648 (647-650) | 666 (664-668) | 0.37 ± 0.05 |
| ss-X-4′ | 649 (648-650) | 668 (665-671) | 0.32 ± 0.04 |
| HJ-X-2′ | 651 (647-654) | 670 (664-673) | 0.44 ± 0.01 |
| HJ-X-3′ | 653 (651-655) | 669 (668-670) | 0.37 ± 0.10 |
| HJ-X-4′ | 652 (650-655) | 669 (668-669) | 0.38 ± 0.08 |
| ds-X-2′ | 646^{†} | 665^{†} | 0.36^{†} |
| ds-X-3′ | 646^{†} | 665^{†} | 0.33^{†} |
| ds-X-4′ | 647^{†} | 667^{†} | 0.31^{†} |

Note that X indicates full range of applicable labeled sequences (ssDNA: A-D and Ac, HJ: A-D, dsDNA: A and Ac) are included. ϕ_{F} reported as the average OF of all assemblies for given series, error indicates the full range observed. Note: †indicates no range observed for dataset.

Since the optical properties of the labeled ssDNA, dsDNA and HJ monomers were well behaved, Cy5-n′ dimers on dsDNA and DNA-HJs were constructed from the constituent strands. Their photophysical properties, including absorption and fluorescence peak positions, OF, and the average fluorescence lifetime (T) are summarized in Table 4.

TABLE 4
Photophysical properties for all Cy5-n′dimer assemblies.

| | Absorption | | | |
|---|---|---|---|---|
| | Peaks | Fluorescence | | |
| Dimer | λₘₐₓ (nm) | λₘₐₓ (nm) | ϕ_{F} | τ (ns) |
| ds-AAc-2′ | 657, —, 607 | 669 | 0.13 | 0.36 |
| ds-AAc-3′ | 665, 637, 598 | 668 | 0.05 | — |
| ds-AAc-4′ | 661, 644, 594 | 668 | 0.04 | — |
| HJ-AB-2′ | 660, —, 605 | 671 | 0.10 | 0.50 |
| HJ-BC-2′ | 659,—, 608 | 671 | 0.17 | 0.39 |
| HJ-CD-2′ | 662, —, 609 | 672 | 0.10 | 0.51 |
| HJ-AD-2′ | 658, —, 608 | 671 | 0.14 | 0.51 |
| HJ-AC-2′ | 664, 638, 604, | 672 | 0.06 | — |
| HJ-BD-2′ | 660, 636, 600 | 670 | 0.06 | — |
| HJ-AB-3′ | 659, 643, 603 | 670 | 0.06 | — |
| HJ-BC-3′ | 660, 643, 604 | 670 | 0.06 | — |
| HJ-CD-3′ | 660, 643, 604 | 669 | 0.12 | — |
| HJ-AD-3′ | 658, 642, 603 | 669 | 0.07 | — |
| HJ-AC-3′ | —, 640, 604 | 668 | 0.04 | — |
| HJ-BD-3′ | —, 638, 603 | 668 | 0.03 | — |
| HJ-AB-4′ | 661, 644, 603 | 673 | 0.03 | — |
| HJ-BC-4′ | 660, 643, 605 | 672 | 0.03 | — |
| HJ-CD-4′ | 661, 642, 604 | 673 | 0.04 | — |
| HJ-AD-4′ | 662, 642, 601 | 673 | 0.02 | — |
| HJ-AC-4′ | 674, 641, 604 | 673 | 0.02 | — |
| HJ-BD-4′ | —, 643, 604 | 669 | 0.01 | — |

Note that all absorption data acquired at room temperature, at 2 μM concentration in 1× TAE buffer with 15 mM MgCl₂ (for HJ assemblies) or at 4 μM concentration in 1× TAE buffer with 100 mM NaCl (for dsDNA assemblies). The three absorbance peak wavelengths listed from longest to shortest correspond to the two absorption peaks resulting from Davydov splitting, and the first vibronic peak. A dash indicates the peak was not measurable. Fluorescence data were acquired upon dilution to 1 μM concentration, with excitation at 615 nm. ϕ_{F} presented here were determined against secondary standards as detailed in the Methods section and SI Table S4. The uncertainty in ϕ_{F} is ±5%. τ indicates the average excited state lifetime (blank entries indicate that no measurement was performed).

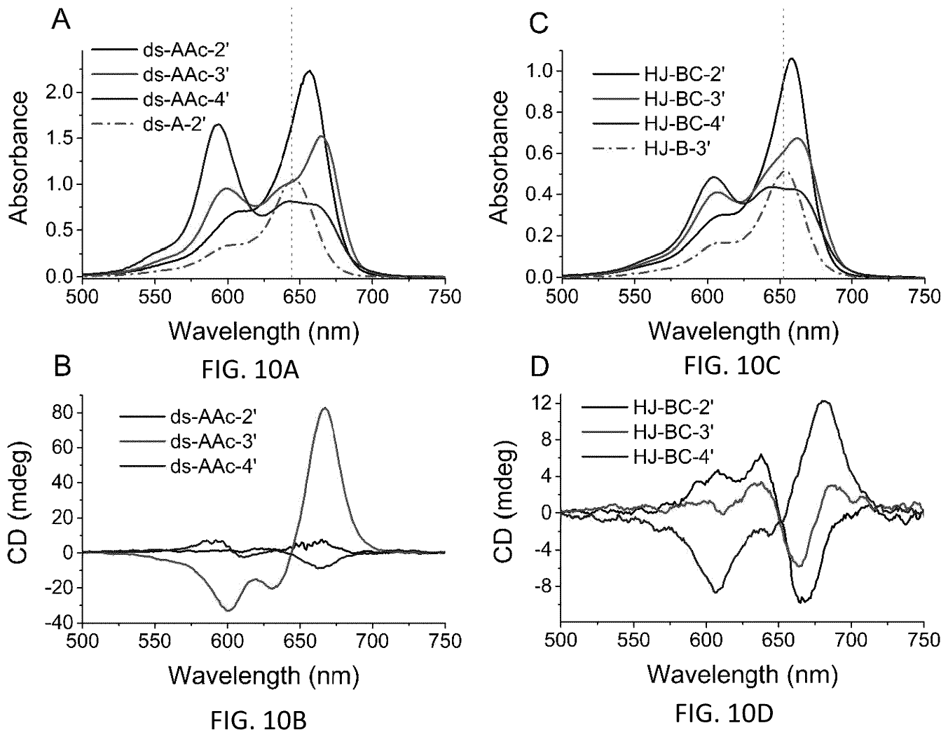

Absorption and Circular Dichroism of Cy5-n′ Dimers on dsDNA and DNA-HJs. The absorption spectra for Cy5-n′ dimers on dsDNA are shown in FIG. 10A. Assembly ds-AAc-2′ exhibits a primary band with a peak at 657 nm that is red shifted from the monomer peak by 11 nm, and a weaker band near 605 nm, which has been described as a vibronic band.^{40, 41} The more gradual fall-off in intensity on the blue side of the primary absorption band suggests the presence of a second weaker electronic transition consistent with Davydov splitting. Both ds-AAc-3′ and ds-AAc-4′ show three distinct absorption bands. The first two bands are due to Davydov splitting of the monomer electronic transition. The third band below 600 nm is vibronic in origin. The vibronic band peaks at 599 nm for ds-AAc-3′, and peaks at 593 nm for ds-AAc-4′ with an increase in relative intensity. This suggest that the shorter 2-carbon linkers favor a more J-like dimer geometry.

The corresponding CD spectra are shown in FIG. 10B. Notably, the CD signal for ds-AAc-2′ is extremely weak, which may result from an ensemble of dimers with both left- and right-handed chirality. In contrast, ds-AAc-3′ shows an intense positive and negative Cotton effect, with three peaks that correspond to the peaks observed in the absorption spectrum. Finally, the CD spectrum for ds-AAc-4′ is also relatively weak (though stronger than ds-AAc-2′) and inverted with respect to the Cy5-2′ and Cy5-3′ dimers. Overall, the CD responses confirm the presence of excitonically coupled dimers, 42 as no CD is observed for monomers.

Because the Cy5 monomer absorption and fluorescence spectra varied somewhat with each sequence for the HJs, we characterized all 18 permutations of HJ dimers when examining the effect of linker length on the optical properties. FIGS. 10C and 10D show the absorption and CD spectra for the adjacent dimers HJ-BC-n′, chosen for the clarity of trend. Overall, the linker length dependence of the absorption and CD spectra for HJ-BC-n′ are qualitatively consistent with the Cy5-n′ dimers on dsDNA.

The absorption spectra of the transverse dimers show increasing relative intensity of the higher energy vibronic band as the linker length increases. The CD spectra of the transverse dimers are highly variable. For example, HJ-AC-2′ and HJ-BD-2′ show weak CD signals, while the CD spectrum of HJ-AC-4′ is nearly inverted from that of HJ-BD-4′, which indicates opposite handedness for opposite transverse dimers. In contrast, HJ-AC-3′ and HJ-BD-3′ have nearly identical CD spectra, indicating identical handedness for opposite transverse dimers.

FIG. 10 shows Linker-length dependence of absorption and CD spectra for Cy5-n′ dimers. A) Absorption and B) CD spectra of ds-AAc-n′. C) Absorption and D) CD spectra of HJ-BC-n′. A reference monomer absorption spectrum is included containing Cy5-2′ on dsDNA or Cy5-3′ on HJ-B (green, dotted lines), with λₘₐₓ indicated by the dashed grey line.

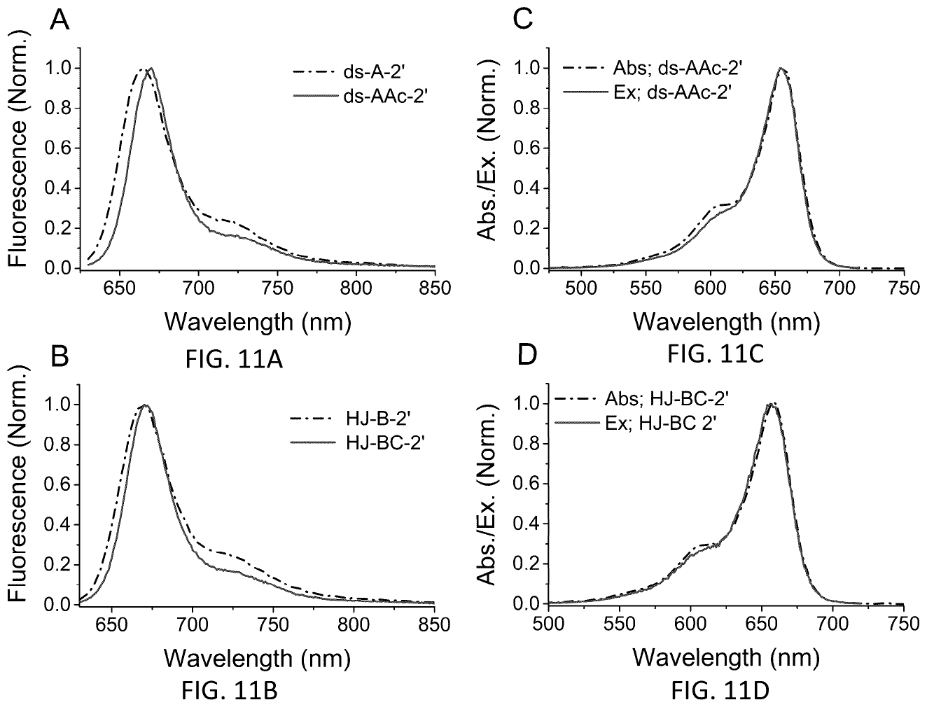

Fluorescence Properties of Cy5-n′ Dimers on dsDNA and DNA-HJs. To further assess the nature of the dye-dye interactions in Cy5-n′ dimers we characterized their fluorescence properties. Beginning with spectral shape, we normalized the fluorescence spectra of all dimers and overlaid them with the nearest representative monomer. The features we closely consider are: 1) fluorescence λₘₐₓ, 2) primary fluorescence band shape, and 3) red/trailing vibronic shoulder relative intensity. Most of the dimers with n′=3 and n′=4 demonstrate fluorescence spectra that are identical to or deviate minimally from the parent monomers. Previous studies of excitonic Cy5 dimers have shown strong fluorescence quenching, 17, 26, 32, 40 so a small monomer-like population that is not quenched can dominate the fluorescence. The monomer-like fluorescence is likely due to a small subpopulation of dimers behaving as monomer-like species where the dyes are spaced relatively far apart (e.g., from DNA breathing), or from small amounts of unhybridized DNA strands containing the Cy5 monomer. The Cy5-2′ dimers are exceptions to this behavior. FIGS. 11A and 11B show normalized fluorescence spectra for ds-AAc-2′ and HJ-BC-2′ overlaid with corresponding monomers. In both instances, the primary fluorescence band slightly narrows and undergoes a small red-shift, concurrent with a relative decrease to the intensity of the vibronic shoulder. These observations are consistent with fluorescence originating primarily from an excitonically coupled dimer with a J-like geometry. That the fluorescence band shapes for the other Cy5-2′ adjacent HJ dimers essentially superimpose onto HJ-BC-2′ indicates that the fluorescence originates from the dimer for all of the adjacent Cy5′-2′ dimers. Additional support comes from fluorescence excitation spectra of Cy5-2′ dimers that largely superimpose onto their respective normalized absorption band shapes (FIGS. 11C and 11D). In contrast, the fluorescence excitation spectra of Cy5-3′ and Cy5-4′ dimers do not match their absorption spectra; instead, they resemble monomer absorption spectra.

FIG. 11 shows Fluorescence spectra of Cy5-2′ dimers on dsDNA and DNA-HJs. Left panels: Normalized fluorescence emission spectra of monomer (black, dash-dotted) and dimers (red, solid) on A) dsDNA and B) HJ-BC, respectively. Right panels: Dimer normalized absorption (black, dashed-dotted) and normalized fluorescence excitation (red) spectra for C) ds-AAc-2′ and D) HJ-BC-2′, respectively.

We also determined the ϕ_{F} for all Cy5-n′ dimers (Table 4). The ϕ_{F} clearly decrease as the linker length increases, regardless of the assembly type. Assembly HJ-CD-3′ is an outlier, exhibiting notably larger ϕ_{F} than the other Cy5-3′ labeled HJs. The Cy5-2′ dimers generally have larger ϕ_{F} than the Cy5-3′ and Cy5-4′ dimers. Even so, the Cy5-2′ dimers are quenched by 3-4 times relative to the parent monomers, suggesting there is a facile mechanism for non-radiative relaxation made available by the proximity of the dyes. The quenching is further substantiated by the shorter fluorescence decay times of the Cy5-2′ dimers on dsDNA and adjacent dimers on DNA-HJs relative to the respective Cy5-2′ monomers. Within the DNA-HJs, the transverse dimers exhibit smaller ϕ_{F} than the adjacent dimers of the same series. This observation is consistent with a low oscillator strength of the emitting state of H-like dimers with relatively long radiative lifetimes and greater susceptibility to quenching from non-radiative relaxation.

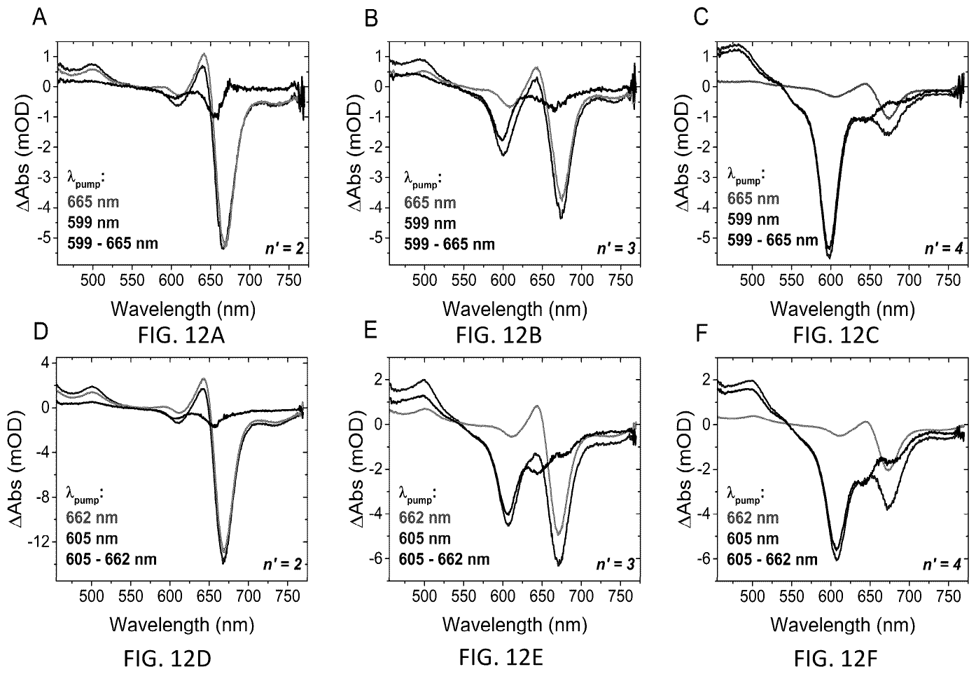

Photo-Selective Ultrafast Transient Absorption. To address the question of how dye linker length affects orientational heterogeneity for Cy5-n′ dimers on dsDNA and DNA-HJs, we use the method of photo-selective ultrafast transient absorption (TA) spectroscopy to probe for possible sub-populations of distinct dimer geometries. This method has been used to demonstrate that solutions of Cy5-3′ adjacent dimers on DNA-HJs consist of a mixture of J-like and H-like dimers.^{18, 21} FIG. 12 shows TA spectra of ds-AAc-n′ (FIGS. 12A-C) and HJ-BC-n′ (FIGS. 12D-F) at a delay time of 1 picosecond (ps) after photoexcitation. For each linker, choosing λₚᵤₘₚ to photoexcite the red absorption edge (665 nm for ds-AAc-2′ and 662 nm for HJ-BC-2′) selects the J-like population, producing a TA spectrum characteristic of a J-like dimer. The ground state bleach (GSB) peaks near 670 nm and is overlapped by a strong excited state absorption (ESA) near 640 nm, which we have assigned previously to a one-exciton to two-exciton transition.⁴⁹ For both n′=3 and n′=4 (FIGS. 12 C-F), the TA spectra for the bluer λpump selecting the vibronic peak (605 nm for ds-AAc-2′ and 599 nm for HJ-BC-2′) do not match the TA spectra for the red Aₚᵤₘₚ, nor do they resemble the corresponding absorption spectra. Instead, the GSB peaks near 600 nm are significantly stronger than expected. Subtraction of the spectra measured at the red λₚᵤₘₚ from that at the bluer λₚᵤₘₚ reveals a hidden, blue-shifted TA spectrum that resembles an H-like absorption spectrum in the region between 575 nm-700 nm. These results resemble previously reported TA spectra for Cy5-3′ transverse dimers on DNA-HJs, which is dominated by a strongly enhanced vibronic band near 600 nm.²¹ Clearly the bluer λₚᵤₘₚ photoselects H-like dimer subpopulations. The relative weight of the GSB near 670 nm is smallest for n′=4 for both dsDNA and HJ-BC. In contrast, for n′=2 dimers (FIGS. 12A and 12B) there is very little difference in the shape of the TA spectra when exciting the samples with the red or blue λₚᵤₘₚ. After applying the same subtraction method, we find a small residual with a peak near 647 nm that may be related to monomer-like species, and a second peak near 605 nm that may be associated with the vibronic band of monomer-like species and, possibly, with the vibronic band of a small H-like dimer sub-population. The photo-selective TA results demonstrate that the ds-AAc-2′ and HJ-BC-2′ samples are nearly homogeneous J-like dimers, whereas the dimer samples with n′=3 and n′=4 are mixtures of J-like and H-like dimers, with the relative fraction of the H-like component increasing with linker length. We conclude that the short n′=2 linker suppresses the orientational heterogeneity observed for Cy5 dimers with longer n′=3 and n′ =4 linkers on both dsDNA and at adjacent sites on HJs. Interestingly, the suppression of orientational heterogeneity correlates with a reduction in the ultrafast fluorescence quenching and an increase in fluorescence quantum yield. The GSB lifetime for n′=2 is longer than for n′=4 dimers on either dsDNA or HJ-BC, and it does not appear to be as strongly reduced from that of its respective monomers.

FIG. 12 shows Photo-selective TA spectra at a 1 ps probe pulse delay time from the pump pulse. Top panel: ds-AAc-n′ dimers. (A) n′=2, (B) n′=3, (C) n′=4. Bottom panel: HJ-BC-n′ adjacent dimers. (D) n′=2, (E) n′=3, (F) n′=4. Red lines correspond to selective excitation of J-like dimers at 662 or 665 nm, Blue lines correspond to selective excitation of H-like dimers. Black lines correspond to the difference between blue-pumped TA spectra and red-pumped TA spectra.

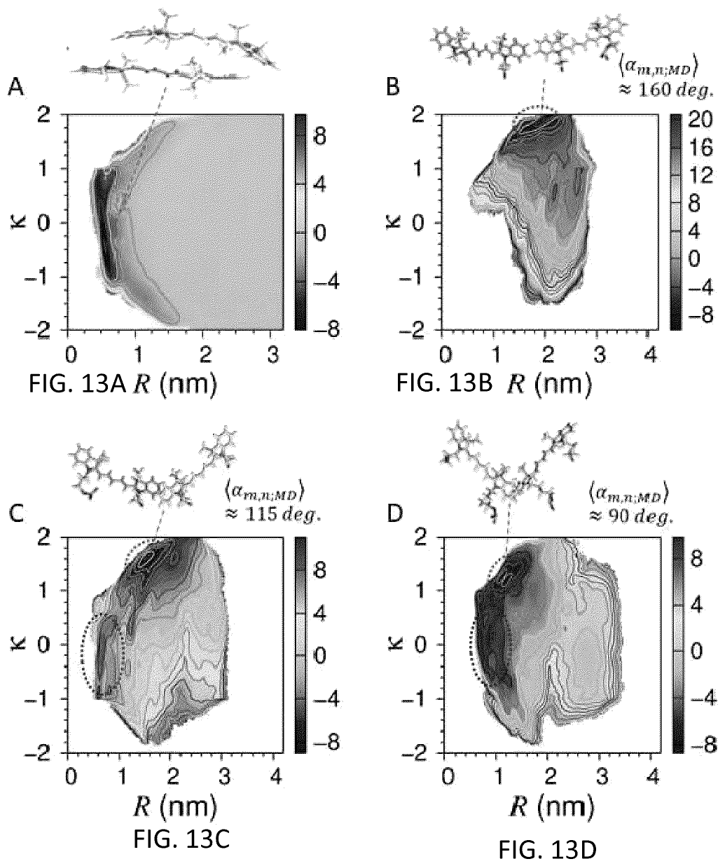

Molecular Dynamics Simulations. To gain additional insight into the effect of linker length on orientational heterogeneity, we performed molecular dynamics (MD) simulations of the Cy5-n′ dimers on dsDNA and then used umbrella sampling to estimate the most probable dimer geometries. Since the Cy5-n′ dimers on dsDNA and HJs show qualitatively similar steady state and TA spectra, we consider the MD simulations for the dimers on dsDNA to be reasonable representations for the dimers on HJs, which would involve much more time-consuming MD simulations. We show the results as heat maps in FIGS. 13A-D, which plot the free energy associated with each pair of dipole orientation factors (κ) and the dye-dye center-to-center separations (R). We consider these data to approximate the probability that these dimer geometries will form in solution. To establish a point of reference, we show the heat map for a free Cy5 dimer without DNA (FIG. 13A). Here, the dyes are predominantly in an H-like dimer geometry with κ between-1 and 1 and R˜ 0.55 nm. Near the free energy minimum (˜−10 kcal/mol) the dyes pack in a staggered co-planar arrangement (FIG. 13A, top) to accommodate the methyl groups on the indole rings. The H-like geometry is consistent with intuition, which is that a pair of hydrophobic dyes in an aqueous environment will aggregate into a tightly packed near co-facial geometry to maximize π-orbital overlap. In contrast, the heat maps for Cy5-3′ and Cy5-4′ dimers on dsDNA (FIGS. ¹³C and 13D) show two free energy minima that correspond to J-like (red dotted ovals) and H-like dimers (blue dotted ovals). The free energy basins cover a broad range of x and R values, especially for Cy5-4′. The lowest free energies in these regions are approximately-10 kcal/mol. For the Cy5-3′ dimer, the H-like region resembles that of the free Cy5 dimer, and there is a barrier of about 6-8 kcal/mol that separates the H-like and J-like regions. For the Cy5-4′ dimer, the free energy basin is relatively flat over a broad range of x and R, and without a clear barrier between the H-like and J-like regions. We attribute the broad free energy basin to the longer, more flexible n′=4 linker. These results predict that samples of Cy5-3′ and Cy5-4′ dimers on dsDNA would consist of a mixture of J-like and H-like dimers, which is consistent with the photo-selective TA results that revealed a mixture of dimer geometries. The Cy5-2′ dimer on dsDNA (FIG. 13B) is qualitatively different. Here, the heat map shows a dominant free energy basin corresponding to J-like dimers (red dotted oval), which is consistent with the photo-selective TA spectra that suggested the sample contains predominantly J-like dimers. Above the heat maps, we show representative J-like dimer geometries taken from the MD simulation, with the DNA removed for clarity. The quantity (α_{m,m:MD}) represents the average of the angles between TDMs (taken to be the along the length of the dye) in the lowest free energy regions for the J-like geometries indicated in FIG. 13.

The MD simulations suggest that orientational heterogeneity for Cy5-n′ dimers on dsDNA can be suppressed using short linkers. This may be understood intuitively as follows. While the hydrophobic nature of the Cy5 dyes favors their proximity, when the linker is short it restricts the dyes from moving into a co-facial orientation via TT-stacking interactions. To reach full co-facial overlap, the DNA scaffold would need to adjust to accommodate the dye movement, however, the degree of adjustment that is needed appears to be energetically unfavorable. Thus, the Cy5 dyes partially overlap to the extent allowed by the short linkers and the DNA scaffold. On the other hand, the increased flexibility of the longer linkers allows the Cy5 dyes greater freedom to move towards co-facial overlap.

FIG. 13 shows Free energy heat maps for Cy5-n′ dimers on dsDNA calculated by umbrella sampling. The heat map colors indicate the free energy in kcal/mol associated with a particular dye separation, R, and orientation factor, x. Dark blue represents the lowest free energies. The red/blue dotted ovals indicate regions where J-like and H-like geometries occur with the lowest free energies. (A) Free Cy5 dimer. (B) Cy5-2′ dimer. (C) Cy5-3′ dimer. (D) Cy5-4′ dimer. Above: Representative dimer geometries for the free Cy5 dimer and Cy5-n′ J-like dimers, with (α_{m,m:MD}) as defined in the main text.

### 4. Materials and Methods

Chemical Dye Synthesis, DNA Synthesis and Purification. All details related to chemical synthesis, automated DNA synthesis, post DNA synthesis processing and purification can be found within the Supporting Information. The ssDNA oligos A, B, C, D and Ac that were either unlabeled or labeled with Cy5-3′ were purchased from Integrated DNA Technologies (Coralville, IA) and used without further purification.

DNA Assembly. The various dsDNA and DNA HJs were prepared in analogous fashion to our previous reports.¹⁷ First, ssDNA was reconstituted in molecular biology grade water to 100 UM solution. Next, for construction of DNA Holliday junctions, equal volumes of the 100 M parent strand (A, B, C, D) solutions were combined and diluted to a final concentration of 10 UM with respect to completed assembly in 1× TAE (40 mM tris(hydroxymethyl) aminomethane, 20 mM acetic acid, 1 mM ethylenediaminetetraacetic acid, pH 8.0) buffer and 15 mM MgCl₂. For DNA duplexes, equal volumes of the A and Acomp (Ac) parent strand solutions were combined and then diluted to 10 UM concentration in the presence of 1× TAE and 100 mM NaCl.²⁶ Note that for Cy5-n′ dimers assembled within dsDNA the use of NaCl instead of MgCl₂ was necessary to prevent aggregation of HJs and the formation of a “mobile tetramer” as described by Cannon et al.⁴⁴ An example of the change in absorption properties of dye-labeled dsDNA, as a function of salt concentration, was found. Once combined, samples were subjected to thermal annealing in a PCR thermal cycler.^{39, 51} Annealing followed a program that maintained the lid temperature at 95° C. constantly, began with a melt at 95° C. for 5 minutes, cooled to 85° C. at a rate of 5 minutes/1° C. drop, held at 85° C. for 10 minutes, then cooled to 4° C. at a cooling rate of 10 minutes/1° C. drop. Samples were held at 4° C. until they were removed for experiments without further purification or stored in the refrigerator in the dark.

Small Molecule and DNA Oligonucleotide Structural Characterization. ¹H and ¹³C NMR spectra were recorded on a Bruker Avance III HD, 400 MHZ spectrometer (Bruker Corporation, Billerica, MA.) Chemical shifts for ¹H and ¹³C NMR spectra are reported relative to the tetramethylsilane (TMS) signal in deuterated solvent (TMS, 8=0.00 ppm). 52 All J values for NMR are reported in hertz. Mass spectral analysis for both small molecules and DNA oligonucleotides was performed using ACQUITY UPLC system equipped with a single quadrupole (SQD2) mass detector (Waters Inc, Milford MA) as described.^{53, 54} In addition to MS, purity of the DNA oligonucleotides was assessed on the ACQUITY UPLC using the photodiode array detector (PDA e) Detector) and fluorescence detector (FLR Detector) modules (sample chromatogram with description of analysis is provided in SI). All LCMS samples were injected from either Millipore-Sigma Supelco or Fisherbrand Optima LCMS grade solvents (water for DNA oligonucleotides and methanol for small molecules). Once injected, oligonucleotides were eluted from a Waters oligonucleotide BEH C18 column (part no. 186003949) using a shallow (6%) increasing gradient of methanol in aqueous 0.05 M TEAA buffer (pH 7.0), the gradients used on a per-sequence basis can be found in SI. Small molecules were injected directly into the SQD2 detector, bypassing the column and in-line detectors.

Absorption Spectra were measured at room temperature using a Cary 60 UV-vis (Agilent Technologies Inc., Santa Clara, CA), in the range of 200-850 nm, with 1 nm intervals and a 0.1s integration time. In all instances, a quartz spectrophotometer cell with 1 cm path length was used. For HJs and ssDNA, sample concentration was 2 μM, for dsDNA sample concentration was 4 μM.

Circular Dichroism (CD) Spectra were measured at room temperature using a J-1500 CD spectrophotometer (Jasco Corp., Tokyo, JPN) in the range of 200-900 nm, with 1 nm intervals at a rate of 100 nm/minute and a 4s integration time. In all instances, a quartz spectrophotometer cell with 1 cm path length was used. For HJs and ssDNA, sample concentration was 2 μM, for dsDNA sample concentration was 4 μM.

Fluorescence Spectra for parent Cy5s were recorded at room temperature on either a FluoroMax-4 or FluoroMax-Plus spectrofluorometer (Horiba Scientific, Piscataway, NJ) in the range of 600-850 nm, with 0.5 nm intervals, 0.3s integration time and excitation at 600 nm, using a quartz spectrophotometer cell with 1 cm path length and an optical density (OD) below 0.1 to prevent inner filter effects. The obtained fluorescence spectra were corrected for wavelength-dependent instrumental sensitivity.

Fluorescence Spectra for all dye-labeled DNA (ssDNA) and assemblies (HJs and dsDNA) were acquired on a Spark microplate reader (Tecan Group, Ltd., Zurich, CH), with excitation source above the plate. A common excitation wavelength of 615 nm was used, and fluorescence was recorded from 630-900 nm, with 1 nm intervals, 50 flashed per nm, and an integration time of 3 milliseconds. For fluorescence excitation spectra, fluorescence was measured at 740 nm while the excitation wavelength was tuned from 500-720 nm. For each sample, 100 μl of a 1 μM solution was added to a well in a 96 well black microtiter plate, resulting in a 1.25 mm pathlength and a maximum OD of 0.05. The obtained fluorescence spectra were corrected for wavelength-dependent instrumental sensitivity. Data were acquired in the follows sets: set 1) all HJ assemblies and parent ssDNA containing Cy5-2′, set 2) all HJ assemblies and parent ssDNA containing Cy5-3′, set 2) all HJ assemblies and parent ssDNA containing Cy5-4′ and set 4) all dsDNA assemblies.

Fluorescence Quantum Yields (F) for parent Cy5s, ssDNA and select HJ assemblies were determined on either a FluoroMax-4 or FluoroMax-Plus spectrofluorometer (Horiba Scientific, Piscataway, NJ) against the 5,19,15,20-tetraphenylporphyrin (TPP) standard (ϕ_{F}=0.07 in toluene).⁵⁵ Reported OF obtained with scan window of 610-850 nm, 0.3s integration time (at 0.5 nm intervals) and excitation at 600 nm, using a quartz spectrophotometer cell with 1 cm path length and an OD below 0.1 to prevent inner filter effects. All fluorescence spectra were corrected for wavelength-dependent instrumental sensitivity. The TPP standard was purchased from Frontier Specialty Chemicals (Logan, UT) and then oxidized with 2,3-dichloro-5,6-cyano-p-benzoquinone (DDQ) to convert the stated 1-3% chlorin impurity to TPP. TPP was cross-referenced against oxazine 720 perchlorate (Luxottica-Exciton, Lockbourne, OH, ϕ_{F}=0.63 in MeOH) 56, 57 upon excitation at 580 nm and found to have agreement of +5%. To mitigate the large time requirement in determining ϕ_{F}, the ϕ_{F} of remaining DNA assemblies were determined by comparing the integrated fluorescence (acquired by Spark microplate reader, described above) against one or more secondary standards. Error with respect to the mean ϕ_{F} was found to be below 5% in all cases, thus the uncertainty is assumed to be the standard ±5% inherent with the original ϕ_{F} determination of the secondary standards.

Transient Absorption Measurements Ultrafast transient absorption (TA) spectra were recorded using a commercial Helios TA spectrometer (Ultrafast Systems, Sarasota, FL) driven by a 1 kHz 100 fs Ti: Sapphire amplifier (Legend Elite, Coherent, Inc., Santa Clara, CA) and a tunable optical parametric amplifier (Topas, Coherent, Inc., Santa Clara, CA). Dye-labeled DNA solutions were prepared to 6.67 μM in 1× TAE buffer with 100 mM NaCl for Cy5-n′ dimers on dsDNA and 15 mM MgCl₂ for Cy5-n′ dimers on DNA-HJs, and measured in both cases in a 2 mm cuvette. The solution was filtered through 0.2-micron PES filters to remove debris that scatter light. The solution was stirred during illumination to minimize photodegradation. The excitation beam was polarized at the magic angle with respect to the white light probe to eliminate artifacts associated with rotational depolarization. All data were chirp corrected using the ultrafast response of pure buffer. The response of the relevant Cy5 monomers was recorded and subtracted from the dimer response to remove small ˜1 ns lifetime photoresponses that arise from monomer or monomer-like structures in the solution. Photoselection of the reddest absorption peak as well as the strongly enhanced 0-1 vibronic shoulder were used to preferentially photoexcite J-like and H-like geometry dimer subpopulations, respectively, and thereby evaluate heterogeneity.

Excited State Lifetimes The excited state lifetimes were measured at room temperature using time-correlated single photon counting (TCSPC). The excitation source was a laser diode (Becker-Hickl GmbH, Berlin, DE) operating at 50 MHz, with a 70 ps pulse, at a wavelength of 630 nm. The dye-DNA structures were placed in a 1 mm path quartz spectrophotometric cell at a concentration between 1-2 μM. Sample fluorescence was collected and sent through a polarizer set to the magic angle and then filtered using a monochromator. A micro channel plate photomultiplier tube (Hamamatsu 2809 Photonics, Hamamatsu, JP) was used to detect the fluorescence with a ˜40 ps instrument response function. The TCSPC waveforms were collected with greater than 10,000 counts in the peak channel.

Molecular Dynamics Simulation: Molecular dynamics (MD) simulations were carried out with the Gromacs 5.1.5 package⁶⁰ using Amber OL 15 force field parameters⁶¹ for DNA and the general Amber force field (GAFF) 62 for dyes. The long-range electrostatics were computed using the particle-mesh Ewald method with a real-space Coulomb cutoff of 1.0 nm. The van der Waals interactions were cut off at 1.0 nm. All bonds were constrained using the LINCS algorithm.⁶³ The neighbor searching algorithm was used with a cutoff of 1.0 nm, and the neighbor list was updated every 10th step. A time step of 2 fs was used for all simulations. The starting dye-DNA structures were built using the UCSF Chimera software, production version 1.13.1.64 Rectangular periodic boundary conditions were used with the box dimensions of ˜13.5 nm×13.5 nm×13.5 nm, ensuring a water layer of at least 1 nm between the DNA and the edge of the box. The systems were solvated in TIP3P water, and Na+ and CI-ions were added to satisfy the salt concentration of 100 mM. The systems were then energy-minimized using the steepest descent method for 1000 steps. The systems were first equilibrated for 10 ns at a constant temperature of 300 K and pressure of 1 atm. The dye-DNA and solvent were coupled separately to temperature baths of the reference temperature (300 K) with a coupling time of 0.1 ps, whereas the pressure was kept constant to a bath of the reference pressure (1 atm) using a coupling time of 1.0 ps. The production trajectories of the dye-DNA complex were calculated for 1 us, keeping the number of particles, temperature, and pressure constant. The Langevin thermostat⁶⁵ was used at 300 K with a coupling constant of 1 ps applied to dye-DNA and water separately. The pressure was maintained at 1 atm isotropically with the Parrinello-Rahman barostat⁶⁶ and a coupling constant of 2.0 ps. The coordinates were written every 100 ps for the analysis.

Umbrella Sampling. The umbrella sampling was performed to compute the free energy in the two-dimensional (R, κ) space, where R is the center-of-mass distance between two dyes and K is the orientation factor defined as

$$κ = \vec{{μ}_{1}} \cdot \vec{{μ}_{2}} - 3 ( \vec{{μ}_{1}} \cdot \vec{n} ) ( \vec{{μ}_{2}} \cdot \vec{n} )$$

with \vec{μ₁} and \vec{μ₂} being the unit dipole vectors of the dyes and at the unit vector connecting two centers of mass for the dyes. A series of windows is evenly placed in the (R, κ) space with 0.2 nm spacing in the r dimension between 0.4 nm and 3.6 nm and 0.2 spacing in the K dimension between-2 and 2, resulting in a total of more than 200 windows for each system. A harmonic bias potential, μᵢ=k(r−rᵢ) 2+κ(κ−κ1)², is applied in each window with the spring constant, k, of 200 KJ/mol.nm², where rᵢ and kᵢ are the reference values of a window i. The initial structure of each window is taken either from structures of a room-temperature 1 μs MD simulation or among the final structures of neighboring windows, whichever has the closest R and κ to the reference values. All biased MD simulations were performed using Gromacs⁶⁰ (version 2022.3) for 20 ns. We used the weighted histogram analysis method (WHAM) 67, 68 to remove the biasing potential and construct the two-dimensional potential of mean force (PMF) after discarding first 2 ns trajectories from the biased simulations.

### 5. Conclusions

In this work we explored how variable-length dye linkers affect the geometry and orientational heterogeneity of excitonically coupled Cy5 dimers on dsDNA and DNA-HJ scaffolds. From experiment, we have shown that the linker length can be used to influence dimer geometry. In particular, short n′=2 linkers limit the dye's degrees of freedom to achieve full co-facial overlap under the driving force of attractive TT-TT interactions. The combination of these attractive forces and restricted access to free volume can be used, through judicious choice of attachment points, to engineer J-like geometries. In addition, we showed that the limited flexibility of the short linker can largely eliminate the orientational heterogeneity that occurs for longer and more flexible n′=3 and 4 linkers. Importantly, the chemistry required for control of aggregate formation is straightforward. The process of shortening commercial linkers from 3 carbons to 2 carbons results in only a modest decrease in the yield of the Cy5-labeled DNA oligo, while lengthening the linker to 4 carbons results in no decrease in yield.

One consequence of the short linker is that it leads to suppression of the non-radiative relaxation that has been reported for closely spaced Cy3 and Cy5 dimers (n′=3) on DNA.^{27, 32, 41} It was previously reported that restricting dye motion through viscous solvents or low temperatures reduces fluorescence quenching where the origin was conjectured to arise from restricting twisting about the polymethine bridge.²⁷ Here, the correlation between a sample of dimers with a greater fraction of population in the co-facial geometry and stronger quenching instead suggests that the origin for the nonradiative recombination may be collisional quenching, facilitated by short dye distances, freedom of motion, and high wavefunction overlap in the co-facial geometry. The restricted motion and partial overlap achieved with the n′=2 linker would suppress such a mechanism, leading to increased excited state lifetime and higher fluorescence quantum yields. Definitive identification of the quenching mechanism operative in Cy dimers would require a careful comparison of different dye attachment geometries as a function of environmental variables, which we plan to pursue in subsequent work.

Going forward, it will be useful to investigate whether other types of short dye linkers can also promote the formation of J-like dimers while suppressing orientational heterogeneity. It will also be useful to investigate the performance of homogeneous J-like dimers as energy transfer relays in cascaded dye arrays on DNA scaffolds.^{31, 50} If highly efficient arrays can be realized, they would find applications as exciton transmission lines in exciton devices.

### FURTHER EMBODIMENTS

Due to the nature of this modification, it is potentially suitable for application on other molecules, including but not limited to other indocyanine-type dies (e.g., Cy3, Cy3.5, Cy5.5).

Depending on the application, for example, utilizing an H-type aggregate as a turn on fluorescence sensor, one would simply select the correct linker length. An added benefit of these modifications is that they do not require additional chemical reactions, when compared to those dyes currently commercially available. J-aggregates are also of interest for biosensing, imaging, quantum computing, optoelectronics, excitonics, and a variety of other optically-based applications.

### Advantages

Utilizing cyanines with variable linker lengths within DNA scaffolds offers the following non-limiting advantages, benefits, and characteristics:
1. The unique ability to tune H-like vs J-like aggregation tendencies, making different sets of photophysical properties accessible.
2. Applications in sensing as fluorescence turn-on (H-like) or ratiometric fluorescence (J-like) materials.
3. Precision control of chromophore locations can facilitate mimicry of different advanced structure formation, for example, light harvesting units of the photosynthetic reaction center.
4. Synthetic methodology matches the complexity (number of transformations, reaction conditions, reagent toxicity/hazards, etc.) of existing, commercially available materials.
5. Aggregate formation is a key feature of systems currently examined for quantum coherence, the ability to modulate the aggregates in a predictable manner is unprecedented.
6. J-like aggregate is suitable in the role of energy donor or energy acceptor for FRET based systems (where H-like aggregates are only suitable as terminal energy acceptors).
7. The short linker appears to mitigate the structural homogeneity of a mixed H-/J-like system making it more J-like. The converse is true for the long linker and the H-like aggregate.

### Concluding Remarks

Although the present subject disclosure has been described in connection with preferred embodiments thereof, it will be appreciated by those skilled in the art that additions, deletions, modifications, and substitutions not specifically described may be made without departing from the spirit and scope of the subject disclosure. Terminology used herein should not be construed as being “means-plus-function” language unless the term “means” is expressly used in association therewith.

The foregoing disclosure of the exemplary embodiments of the present subject disclosure has been presented for purposes of illustration and description. It is not intended to be exhaustive or to limit the subject disclosure to the precise forms disclosed. Many variations and modifications of the embodiments described herein will be apparent to one of ordinary skill in the art in light of the above disclosure. The scope of the subject disclosure is to be defined only by the claims appended hereto, and by their equivalents.

Further, in describing representative embodiments of the present subject disclosure, the specification may have presented the method and/or process of the present subject disclosure as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present subject disclosure should not be limited to the performance of their steps in the order written, and one skilled in the art can readily appreciate that the sequences may be varied and still remain within the spirit and scope of the present subject disclosure.

All documents mentioned herein are hereby incorporated by reference for the purpose of disclosing and describing the particular materials and methodologies for which the document was cited.

The following references, cited within this disclosure, are incorporated by reference herein in their entirety into this disclosure:
(1) Seeman, N. C. Structural DNA Nanotechnology; Cambridge University Press, 2016. DOI: 10.1017/CBO9781139015516.
(2) Mathur, D.; Díaz, S. A.; Hildebrandt, N.; Pensack, R. D.; Yurke, B.; Biaggne, A.; Li, L.; Melinger, J. S.; Ancona, M. G.; Knowlton, W. B.; et al. Pursuing excitonic energy transfer with programmable DNA-based optical breadboards. Chemical Society Reviews 2023, 52 (22), 7848-7948. DOI: 10.1039/DOCS00936A.
(3) Satyabola, D.; Prasad, A.; Yan, H.; Zhou, X. Bioinspired Photonic Systems Directed by Designer DNA Nanostructures. ACS Applied Optical Materials 2024. DOI: 10.1021/acsaom.⁴c00103.
(4) Mathur, D.; Kim, Y. C.; Díaz, S. A.; Cunningham, P. D.; Rolczynski, B. S.; Ancona, M. G.; Medintz, I. L.; Melinger, J. S. Can a DNA Origami Structure
Constrain the Position and Orientation of an Attached Dye Molecule? The Journal of Physical Chemistry C 2021, 125 (2), 1509-1522. DOI: 10.1021/acs.jpcc.⁰c09258.
(5) Sengupta, S.; Würthner, F. Chlorophyll J-Aggregates: From Bioinspired Dye Stacks to Nanotubes, Liquid Crystals, and Biosupramolecular Electronics. Accounts of Chemical Research 2013, 46 (11), 2498-2512. DOI: 10.1021/ar400017u.
(6) Hara, Y.; Fujii, T.; Kashida, H.; Sekiguchi, K.; Liang, X.; Niwa, K.; Takase, T.; Yoshida, Y.; Asanuma, H. Coherent Quenching of a Fluorophore for the Design of a Highly Sensitive In-Stem Molecular Beacon. Angewandte Chemie International Edition 2010, 49 (32), 5502-5506. DOI: 10.1002/anie.^{201001459.}
(7) Sawaya, N. P. D.; Rappoport, D.; Tabor, D. P.; Aspuru-Guzik, A. Excitonics: A Set of Gates for Molecular Exciton Processing and Signaling. ACS Nano 2018, 12 (7), 6410-6420. DOI: 10.1021/acsnano. 8b00584.
(8) Cannon, B. L.; Kellis, D. L.; Davis, P. H.; Lee, J.; Kuang, W.; Hughes, W. L.; Graugnard, E.; Yurke, B.; Knowlton, W. B. Excitonic AND Logic Gates on DNA Brick Nanobreadboards. ACS Photonics 2015, 2 (3), 398-404. DOI: 10.1021/ph500444d.
(9) Yurke, B. DNA Assembly of Dye Aggregates-A Possible Path to Quantum Computing. In Visions of DNA Nanotechnology at 40 for the Next 40: A Tribute to Nadrian C. Seeman, Jonoska, N., Winfree, E. Eds.; Springer Nature Singapore, 2023; pp 125-169.
(10) Castellanos, M. A.; Dodin, A.; Willard, A. P. On the design of molecular excitonic circuits for quantum computing: the universal quantum gates. Physical Chemistry Chemical Physics 2020, 22 (5), 3048-3057. DOI: 10.1039/C9CP05625D.
(11) Kato, T.; Kashida, H.; Kishida, H.; Yada, H.; Okamoto, H.; Asanuma, H. Development of a Robust Model System of FRET using Base Surrogates Tethering Fluorophores for Strict Control of Their Position and Orientation within DNA Duplex. Journal of the American Chemical Society 2013, 135 (2), 741-750. DOI: 10.1021/ja309279w.
(12) Hübner, K.; Joshi, H.; Aksimentiev, A.; Stefani, F. D.; Tinnefeld, P.; Acuna, G. P. Determining the In-Plane Orientation and Binding Mode of Single Fluorescent Dyes in DNA Origami Structures. ACS Nano 2021, 15 (3), 5109-5117. DOI: 10.1021/acsnano.⁰c10259.
(13) Cervantes-Salguero, K.; Biaggne, A.; Youngsman, J. M.; Ward, B. M.; Kim, Y. C.; Li, L.; Hall, J. A.; Knowlton, W. B.; Graugnard, E.; Kuang, W. Strategies for Controlling the Spatial Orientation of Single Molecules Tethered on DNA Origami Templates Physisorbed on Glass Substrates: Intercalation and Stretching. International Journal of Molecular Sciences 2022, 23 (14), 7690.
(14) Adamczyk, A. K.; Huijben, T. A. P. M.; Sison, M.; Di Luca, A.; Chiarelli, G.; Vanni, S.; Brasselet, S.; Mortensen, K. I.; Stefani, F. D.; Pilo-Pais, M.; et al. DNA Self-Assembly of Single Molecules with Deterministic Position and Orientation. ACS Nano 2022, 16 (10), 16924-16931. DOI: 10.1021/acsnano.²c06936.
(15) Hart, S. M.; Wang, X.; Guo, J.; Bathe, M.; Schlau-Cohen, G. S. Tuning Optical Absorption and Emission Using Strongly Coupled Dimers in Programmable DNA Scaffolds. The Journal of Physical Chemistry Letters 2022, 13 (7), 1863-1871. DOI: 10.1021/acs.jpclett.¹c03848.
(16) Hart, S. M.; Chen, W. J.; Banal, J. L.; Bricker, W. P.; Dodin, A.; Markova, L.; Vyborna, Y.; Willard, A. P.; Haner, R.; Bathe, M.; et al. Engineering couplings for exciton transport using synthetic DNA scaffolds. Chem 2021, 7 (3), 752-773. DOI: 10.1016/j.chempr.^{2020.12.020.}
(17) Díaz, S. A.; Pascual, G.; Patten, L. K.; Roy, S. K.; Meares, A.; Chiriboga, M.; Susumu, K.; Knowlton, W. B.; Cunningham, P. D.; Mathur, D.; et al. Towards control of excitonic coupling in DNA-templated Cy5 aggregates: the principal role of chemical substituent hydrophobicity and steric interactions. Nanoscale 2023. DOI: 10.1039/D2NR05544A.
(18) Pascual, G., Diaz, Sebastian A., Roy, Simon K., Meares, Adam, Chiriboga, Matthew, Susumu, Kimihiro, Mathur, Divita, Cunningham, Paul D. Medintz, Igor L., Yurke, Bernard, Knowlton, William B., Melinger, Joseph S., Lee, Jeunghoon. Towards tunable exciton delocalization in DNA Holliday junction-templated indodicarbocyanine 5 (Cy5) dye derivative heterodimers. Nanoscale Horizons 2024. DOI: 10.1039/D4NH00225C.
(19) Zhao, X.; Du, J.; Sun, W.; Fan, J.; Peng, X. Regulating Charge Transfer in Cyanine Dyes: A Universal Methodology for Enhancing Cancer Phototherapeutic Efficacy. Accounts of Chemical Research 2024, 57 (17), 2582-2593. DOI: 10.1021/acs.accounts.⁴c00399.
(20) Huff, J. S.; Díaz, S. A.; Barclay, M. S.; Chowdhury, A. U.; Chiriboga, M.; Ellis, G. A.; Mathur, D.; Patten, L. K.; Roy, S. K.; Sup, A.; et al. Tunable Electronic Structure via DNA-Templated Heteroaggregates of Two Distinct Cyanine Dyes. The Journal of Physical Chemistry C 2022. DOI: 10.1021/acs.jpcc.²c04336.
(21) Huff, J. S.; Turner, D. B.; Mass, O. A.; Patten, L. K.; Wilson, C. K.; Roy, S. K.; Barclay, M. S.; Yurke, B.; Knowlton, W. B.; Davis, P. H.; et al. Excited-State Lifetimes of DNA-Templated Cyanine Dimer, Trimer, and Tetramer Aggregates: The Role of Exciton Delocalization, Dye Separation, and DNA Heterogeneity. The Journal of Physical Chemistry B 2021, 125 (36), 10240-10259. DOI: 10.1021/acs.jpcb.¹c04517.
(22) Brush, C. K., Anderson, E.D. Preparation of indocarbocyanine dye-linked phosphoramidites. U.S. Pat. No. 5,556,959, 1996.
(23) Brush, C. K., Anderson, E.D. Preparation of indocarbocyanine and benzindocarbocyanine dye-linked phosphoramidites. U.S. Pat. No. 5,808,044, 1998.
(24) Meares, A.; Susumu, K.; Mathur, D.; Lee, S. H.; Mass, O. A.; Lee, J.; Pensack, R. D.; Yurke, B.; Knowlton, W. B.; Melinger, J. S.; et al. Synthesis of Substituted Cy5 Phosphoramidite Derivatives and Their Incorporation into Oligonucleotides Using Automated DNA Synthesis. ACS Omega 2022, 7 (13), 11002-11016. DOI: 10.1021/acsomega.¹c06921.
(25) Nicoli, F.; Roos, M. K.; Hemmig, E. A.; Di Antonio, M.; de Vivie-Riedle, R.; Liedl, T. Proximity-Induced H-Aggregation of Cyanine Dyes on DNA-Duplexes. The Journal of Physical Chemistry A 2016, 120 (50), 9941-9947. DOI: 10.1021/acs.jpca.⁶b10939.
(26) Markova, L. I.; Malinovskii, V. L.; Patsenker, L. D.; Häner, R. J-vs. H-type assembly: pentamethine cyanine (Cy5) as a near-IR chiroptical reporter. Chemical Communications 2013, 49 (46), 5298-5300. DOI: 10.1039/C3CC42103A.
(27) Cunningham, P. D.; Kim, Y. C.; Díaz, S. A.; Buckhout-White, S.; Mathur, D.; Medintz, I. L.; Melinger, J. S. Optical Properties of Vibronically Coupled Cy3 Dimers on DNA Scaffolds. The Journal of Physical Chemistry B 2018, 122 (19), 5020-5029. DOI: 10.1021/acs.jpcb.⁸b02134.
(28) Kringle, L.; Sawaya, N. P. D.; Widom, J.; Adams, C.; Raymer, M. G.; Aspuru-Guzik, A.; Marcus, A. H. Temperature-dependent conformations of exciton-coupled Cy3 dimers in double-stranded DNA. The Journal of Chemical Physics 2018, 148 (8), 085101. DOI: 10.1063/1.5020084 (acccessed 2022 Jun. 16).
(29) Carter-Fenk, K.; Herbert, J. M. Electrostatics does not dictate the slip-stacked arrangement of aromatic IT-IT interactions. Chemical Science 2020, 11 (26), 6758-6765. DOI: 10.1039/DOSC02667K.
(30) Cabaleiro-Lago, E. M.; Rodríguez-Otero, J. On the Nature of 0-0, 0-IT, and TT-TT Stacking in Extended Systems. ACS Omega 2018, 3 (8), 9348-9359. DOI: 10.1021/acsomega.⁸b01339.
(31) Díaz, S. A.; Kim, Y. C.; Cunningham, P. D.; Mathur, D.; Medintz, I. L.; Kellis, D. L.; Yurke, B.; Knowlton, W. B.; Melinger, J. S. Excitonically Coupled Cyanine Dye Dimers as Optical Energy Transfer Relays on DNA Templates. ACS Applied Optical Materials 2024. DOI: 10.1021/acsaom.³c00459.
(32) Huff, J. S.; Davis, P. H.; Christy, A.; Kellis, D. L.; Kandadai, N.; Toa, Z. S. D.; Scholes, G. D.; Yurke, B.; Knowlton, W. B.; Pensack, R. D. DNA-Templated Aggregates of Strongly Coupled Cyanine Dyes: Nonradiative Decay Governs Exciton Lifetimes. The Journal of Physical Chemistry Letters 2019, 10 (10), 2386-2392. DOI: 10.1021/acs.jpclett.⁹b00404.
(33) Davydov, A. S. The Theory of Molecular Excitons. Soviet Physics Uspekhi 1964, 7 (2), 145. DOI: 10.1070/PU1964v007n02ABEH003659.
(34) Kasha, M. Energy Transfer Mechanisms and the Molecular Exciton Model for Molecular Aggregates. Radiation Research 1963, 20 (1), 55-70. DOI: 10.2307/3571331.
(35) Kasha, M.; Rawls, H. R.; Ashraf El-Bayoumi, M. The exciton model in molecular spectroscopy. 1965, 11 (3-4), 371-392. DOI: 10.1351/pac196511030371.
(36) Polyutov, S.; Kühn, O.; Pullerits, T. Exciton-vibrational coupling in molecular aggregates: Electronic versus vibronic dimer. Chemical Physics 2012, 394 (1), 21-28. DOI: 10.1016/j.chemphys.^{2011.12.006.}
(37) Schröter, M.; Ivanov, S. D.; Schulze, J.; Polyutov, S. P.; Yan, Y.; Pullerits, T.; Kühn, O. Exciton-vibrational coupling in the dynamics and spectroscopy of Frenkel excitons in molecular aggregates. Physics Reports 2015, 567, 1-78. DOI: 10.1016/j.physrep.^{2014.12.001.}
(38) Kretschy, N. S., M.M. Comparison of the Sequence-Dependent Fluorescence of the Cyanine Dyes Cy3, Cy5, DyLight DY547 and DyLight DY647 on Single-Stranded DNA. PLoS ONE 2014, 9 (1), e⁸⁵⁶⁰⁵. DOI: 10.1371/journal.pone.^{0085605.}
(39) Chowdhury, A. U.; Díaz, S. A.; Huff, J. S.; Barclay, M. S.; Chiriboga, M.; Ellis, G. A.; Mathur, D.; Patten, L. K.; Sup, A.; Hallstrom, N.; et al. Tuning between Quenching and Energy Transfer in DNA-Templated Heterodimer Aggregates. The Journal of Physical Chemistry Letters 2022, 13 (12), 2782-2791. DOI: 10.1021/acs.jpclett.²c00017.
(40) Cannon, B. L.; Patten, L. K.; Kellis, D. L.; Davis, P. H.; Lee, J.; Graugnard, E.; Yurke, B.; Knowlton, W. B. Large Davydov Splitting and Strong Fluorescence Suppression: An Investigation of Exciton Delocalization in DNA-Templated Holliday Junction Dye Aggregates. The Journal of Physical Chemistry A 2018, 122 (8), 2086-2095. DOI: 10.1021/acs.jpca.⁷b12668.
(41) Rolczynski, B. S.; Díaz, S. A.; Kim, Y. C.; Medintz, I. L.; Cunningham, P. D.; Melinger, J. S. Understanding Disorder, Vibronic Structure, and Delocalization in Electronically Coupled Dimers on DNA Duplexes. The Journal of Physical Chemistry A 2021, 125 (44), 9632-9644. DOI: 10.1021/acs.jpca.¹c07205.
(42) Lewis, F. D.; Liu, X.; Wu, Y.; Zuo, X. Stepwise Evolution of the Structure and Electronic Properties of DNA. Journal of the American Chemical Society 2003, 125 (42), 12729-12731. DOI: 10.1021/ja036449k.
(43) Kühn, O.; Renger, T.; May, V. Theory of exciton-vibrational dynamics in molecular dimers. Chemical Physics 1996, 204 (1), 99-114. DOI: 10.1016/0301-0104 (95) 00448-3.
(44) Cannon, B. L.; Kellis, D. L.; Patten, L. K.; Davis, P. H.; Lee, J.; Graugnard, E.; Yurke, B.; Knowlton, W. B. Coherent Exciton Delocalization in a Two-State DNA-Templated Dye Aggregate System. The Journal of Physical Chemistry A 2017, 121 (37), 6905-6916. DOI: 10.1021/acs.jpca.⁷b04344.
(45) Roy, S. K.; Mass, O. A.; Kellis, D. L.; Wilson, C. K.; Hall, J. A.; Yurke, B.; Knowlton, W. B. Exciton Delocalization and Scaffold Stability in Bridged Nucleotide-Substituted, DNA Duplex-Templated Cyanine Aggregates. The Journal of Physical Chemistry B 2021, 125 (50), 13670-13684. DOI: 10.1021/acs.jpcb.¹c07602.
(46) Knapp, E. W. Lineshapes of molecular aggregates, exchange narrowing and intersite correlation. Chemical Physics 1984, 85 (1), 73-82. DOI: 10.1016/S0301-0104 (84) 85174-5.
(47) Walczak, P. B.; Eisfeld, A.; Briggs, J. S. Exchange narrowing of the J band of molecular dye aggregates. The Journal of Chemical Physics 2008, 128 (4), 044505. DOI: 10.1063/1.2823730.
(48) Pascual, G.; Roy, S. K.; Barcenas, G.; Wilson, C. K.; Cervantes-Salguero, K.; Obukhova, O. M.; Krivoshey, A. I.; Terpetschnig, E. A.; Tatarets, A. L.; Li, L.; et al. Effect of hydrophilicity-imparting substituents on exciton delocalization in squaraine dye aggregates covalently templated to DNA Holliday junctions. Nanoscale 2024, 16 (3), 1206-1222. DOI: 10.1039/D3NR04499H.
(49) Cunningham, P. D.; Diaz, S. A.; Yurke, B.; Medintz, I. L.; Melinger, J. S. Delocalized Two-Exciton States in DNA Scaffolded Cyanine Dimers. Journal of Physical Chemistry B 2020, 124 (37), 8042-8049. DOI: 10.1021/acs.jpcb.⁰c06732.
(50) Díaz, S. A.; Buckhout-White, S.; Ancona, M. G.; Spillmann, C. M.; Goldman, E. R.; Melinger, J. S.; Medintz, I. L. Extending DNA-Based Molecular Photonic Wires with Homogeneous Forster Resonance Energy Transfer. Advanced Optical Materials 2016, 4 (3), 399-412. DOI: 10.1002/adom.^{201500554.}
(51) Huff, J. S.; Díaz, S. A.; Barclay, M. S.; Chowdhury, A. U.; Chiriboga, M.; Ellis, G. A.; Mathur, D.; Patten, L. K.; Roy, S. K.; Sup, A.; et al. Tunable Electronic Structure via DNA-Templated Heteroaggregates of Two Distinct Cyanine Dyes. The Journal of Physical Chemistry C 2022, 126 (40), 17164-17175. DOI: 10.1021/acs.jpcc.²c04336.
(52) Fulmer, G. R.; Miller, A. J. M.; Sherden, N. H.; Gottlieb, H. E.; Nudelman, A.; Stoltz, B. M.; Bercaw, J. E.; Goldberg, K. I. NMR Chemical Shifts of Trace Impurities: Common Laboratory Solvents, Organics, and Gases in Deuterated Solvents Relevant to the Organometallic Chemist. Organometallics 2010, 29 (9), 2176-2179. DOI: 10.1021/om100106e.
(53) Breger, J. C.; Susumu, K.; Lasarte-Aragonés, G.; Díaz, S. A.; Brask, J.; Medintz, I. L. Quantum Dot Lipase Biosensor Utilizing a Custom-Synthesized Peptidyl-Ester Substrate. ACS Sens 2020, 5 (5), 1295-1304. DOI: 10.1021/acssensors.⁹b02291.
(54) Gemmill, K. B.; Díaz, S. A.; Blanco-Canosa, J. B.; Deschamps, J. R.; Pons, T.; Liu, H.-W.; Deniz, A. A.; Melinger, J. S.; Oh, E.; Susumu, K.; et al. Examining the Polyproline Nanoscopic Ruler in the Context of Quantum Dots. Chemistry of Materials 2015, 27, 6222-6237. DOI: 10.1021/acs.chemmater.⁵b03181.
(55) Mandal, A. K.; Taniguchi, M.; Diers, J. R.; Niedzwiedzki, D. M.; Kirmaier, C.; Lindsey, J. S.; Bocian, D. F.; Holten, D. Photophysical Properties and Electronic Structure of Porphyrins Bearing Zero to Four meso-Phenyl Substituents: New Insights into Seemingly Well Understood Tetrapyrroles. The Journal of Physical Chemistry A 2016, 120 (49), 9719-9731. DOI: 10.1021/acs.jpca.⁶b09483.
(56) Drexhage, K. H. Fluorescence Efficiency of Laser Dyes*. Journal of Research of the National Bureau of Standards. Section A, Physics and Chemistry 1976, 80A, 421-428.
(57) Sens, R.; Drexhage, K. H. Fluorescence quantum yield of oxazine and carbazine laser dyes. Journal of Luminescence 1981, 24-25, 709-712. DOI: 10.1016/0022-2313 (81) 90075-2.
(58) Abramavicius, D.; Palmieri, B.; Mukamel, S. Extracting single and two-exciton couplings in photosynthetic complexes by coherent two-dimensional electronic spectra. Chemical Physics 2009, 357 (1), 79-84. DOI: 10.1016/j.chemphys.^{2008.10.010.}
(59) Hestand, N. J.; Spano, F. C. Molecular Aggregate Photophysics beyond the Kasha Model: Novel Design Principles for Organic Materials. Accounts of Chemical Research 2017, 50 (2), 341-350. DOI: 10.1021/acs.accounts.6b00576.
(60) Van Der Spoel, D.; Lindahl, E.; Hess, B.; Groenhof, G.; Mark, A. E.; Berendsen, H. J. C. GROMACS: Fast, flexible, and free. Journal of Computational Chemistry 2005, 26 (16), 1701-1718. DOI: 10.1002/jcc. 20291.
(61) Hornak, V.; Abel, R.; Okur, A.; Strockbine, B.; Roitberg, A.; Simmerling, C. Comparison of multiple Amber force fields and development of improved protein backbone parameters. Proteins: Structure, Function, and Bioinformatics 2006, 65 (3), 712-725. DOI: 10.1002/prot.^{21123.}
(62) Wang, J.; Wolf, R. M.; Caldwell, J. W.; Kollman, P. A.; Case, D. A. Development and testing of a general amber force field. Journal of Computational Chemistry 2004, 25 (9), 1157-1174. DOI: 10.1002/jcc.^{20035.}
(63) Hess, B.; Bekker, H.; Berendsen, H. J. C.; Fraaije, J. G. E. M. LINCS: A linear constraint solver for molecular simulations. Journal of Computational Chemistry 1997, 18 (12), 1463-1472. DOI: 10.1002/(SICI) 1096-987X (199709) 18:12<1463:: AID-JCC4>3.0.CO;2-H.
(64) Pettersen, E. F.; Goddard, T. D.; Huang, C. C.; Couch, G. S.; Greenblatt, D. M.; Meng, E. C.; Ferrin, T. E. UCSF Chimera—a visualization system for exploratory research and analysis. J Comput Chem 2004, 25 (13), 1605-1612. DOI: 10.1002/jcc.^{20084.}
(65) Bussi, G.; Donadio, D.; Parrinello, M. Canonical sampling through velocity rescaling. The Journal of Chemical Physics 2007, 126 (1), 014101. DOI: 10.1063/1.2408420.
(66) Parrinello, M.; Rahman, A. Polymorphic transitions in single crystals: A new molecular dynamics method. Journal of Applied Physics 1981, 52 (12), 7182-7190. DOI: 10.1063/1.328693.
(67) Ferrenberg, A. M.; Swendsen, R. H. Optimized Monte Carlo data analysis. Physical Review Letters 1989, 63 (12), 1195-1198. DOI: 10.1103/PhysRevLett.^{63.1195.}
(68) Kumar, S.; Rosenberg, J. M.; Bouzida, D.; Swendsen, R. H.; Kollman, P. A. The weighted histogram analysis method for free-energy calculations on biomolecules. I. The method. Journal of Computational Chemistry 1992, 13 (8), 1011-1021. DOI: 10.1002/jcc.^{540130812.}

The following additional references, not specifically recited but also related to this disclosure, are also incorporated by reference herein in their entirety into this disclosure:
69) Mujumdar, R. B.; Ernst, L. A.; Mujumdar, S. R.; Lewis, C. J.; Waggoner, A. S. Cyanine dye labeling reagents-sulfoindocyaninen succinimidyl esters. Bioconjugate Chemistry 1993, 4 (2), 105.
70) Medintz et al. Indodicarbocyanine Phosphoramidites with Bathochromically Shifted Absorption and Emission, and Tunable Hydrophobicity. US2023250126A1, 2023.
71) Gerowska, M.; Hall, L.; Richardson, J.; Shelbourne, M.; Brown, T. Efficient reverse click labeling of azide oligonucleotides with multiple alkynyl Cy-Dyes applied to the synthesis of HyBeacon probes for genetic analysis. Tetrahedron 2012, 68 (3), 857.
72) Holzhauser, C.; Berndl, S.; Menacher, F.; Breunig, M.; Gopferich, A.; Wagenknecht, H. A. Synthesis and Optical Properties of Cyanine Dyes as Fluorescent DNA Base Substitutions for Live Cell Imaging. European Journal of Organic Chemistry 2010, (7), 1239.
73) Medintz, I. L.; Mauro, J. M. Use of a cyanine dye as a reporter probe in reagentless maltose sensors based on E-coli maltose binding protein. Analytical Letters 2004, 37 (2), 191.
74) Buckhout-White, S.; Brown, C. W.; Hastman, D. A.; Ancona, M. G.; Melinger, J. S.; Goldman, E. R.; Medintz, I. L. Expanding molecular logic capabilities in DNA-scaffolded multiFRET triads. RSC Advances 2016, 6 (100), 97587.
75) Mathur, D.; Samanta, A.; Ancona, M. G.; Díaz, S. A.; Kim, Y. C.; Melinger, J. S.; Goldman, E. R.; Sadowski, J. P.; Ong, L. L.; Yin, P.; et al. Understanding Forster Resonance Energy Transfer in the Sheet Regime with DNA Brick-Based Dye Networks. ACS Nano 2021, 15, 16452.
76) Cunningham, P. D.; Khachatrian, A.; Buckhout-White, S.; Deschamps, J. R.; Goldman, E. R.; Medintz, I. L.; Melinger, J. S. Resonance energy transfer in DNA duplexes labeled with localized dyes. Journal of Physical Chemistry B 2014, 118 (50), 14555.
77) Biaggne, A.; Knowlton, W. B.; Yurke, B.; Lee, J.; Li, L. Substituent Effects on the Solubility and Electronic Properties of the Cyanine Dye Cy5: Density Functional and Time-Dependent Density Functional Theory Calculations. Molecules 2021, 26 (3), 524.

What is claimed is:

1. A compound comprising a variable linker phosphoramidite comprising a structure as shown:

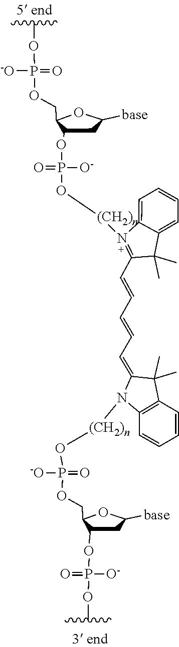

2. The compound of claim 1, wherein n=2 or 4.

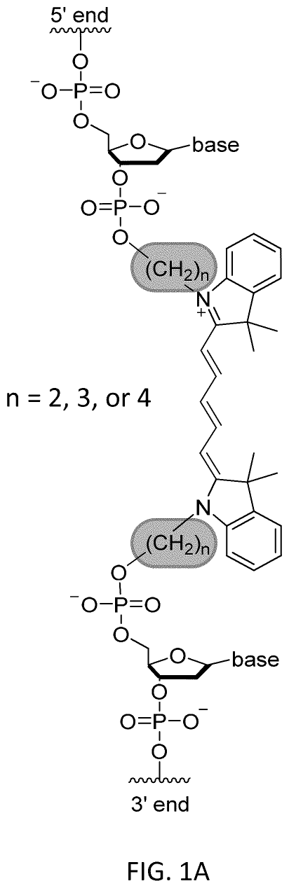

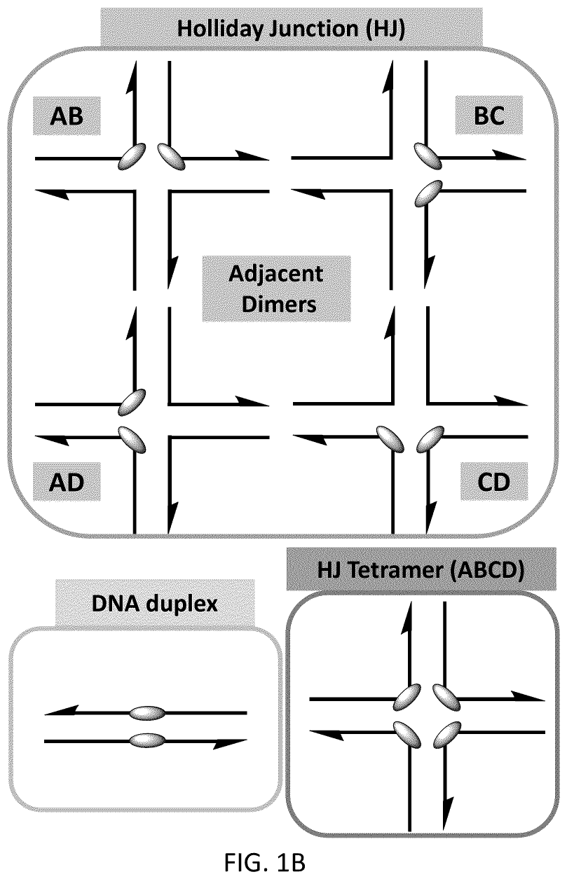

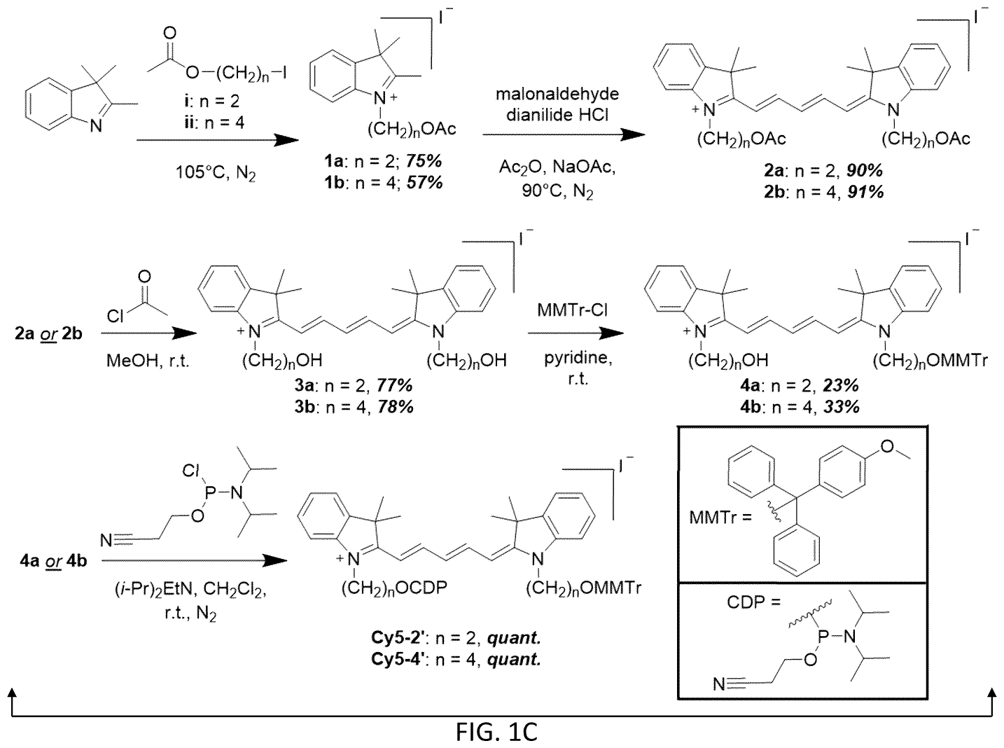

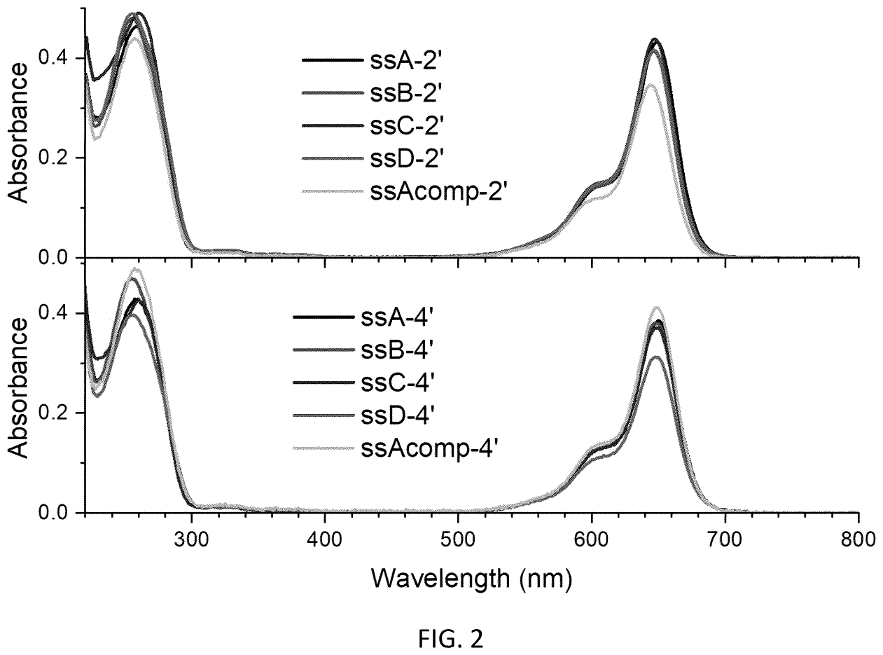

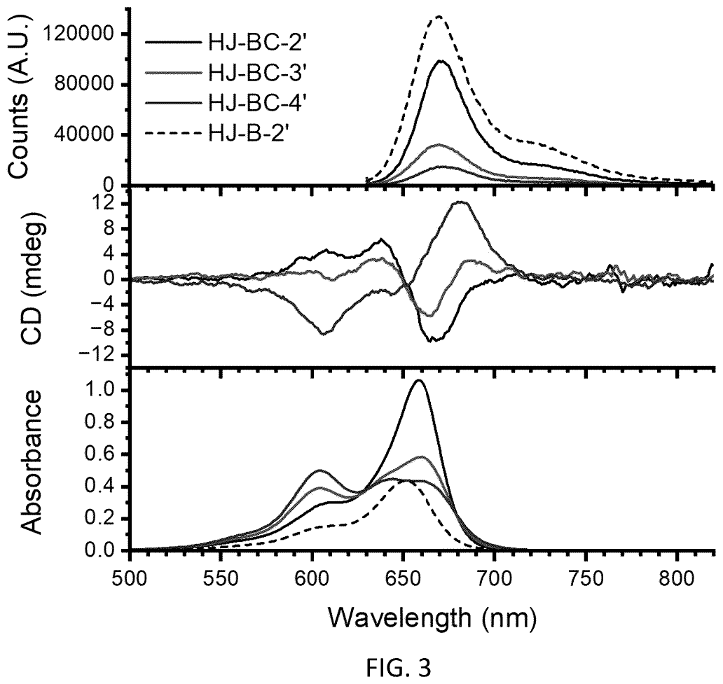

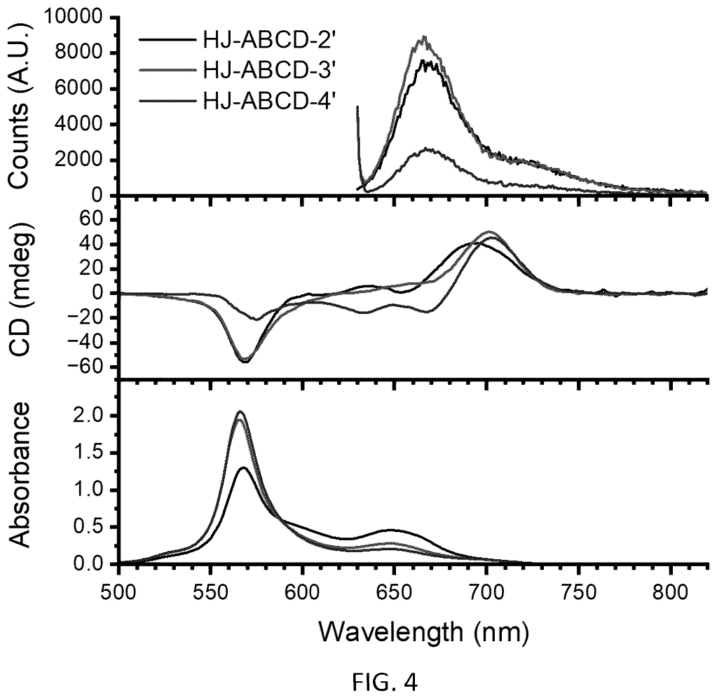

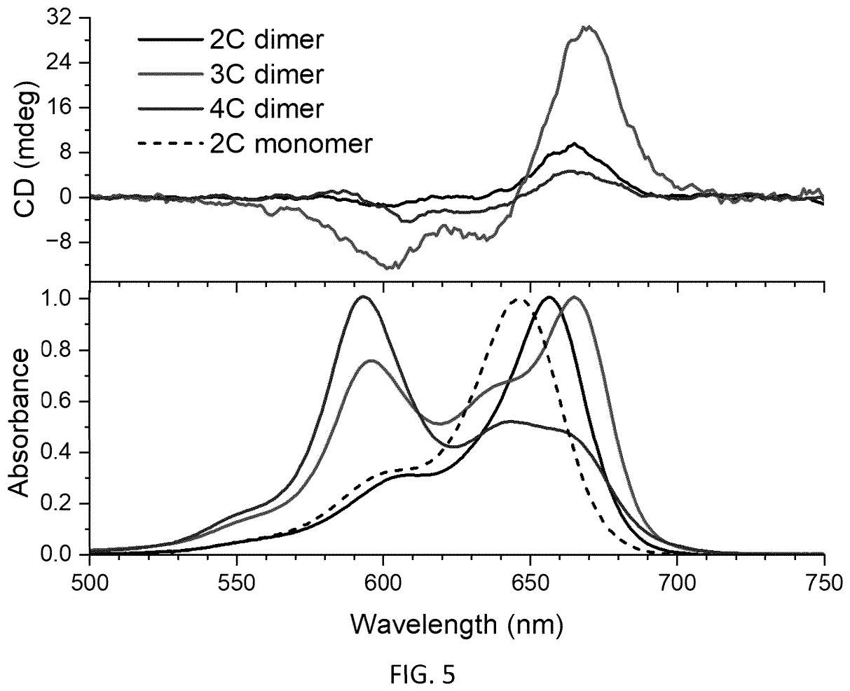

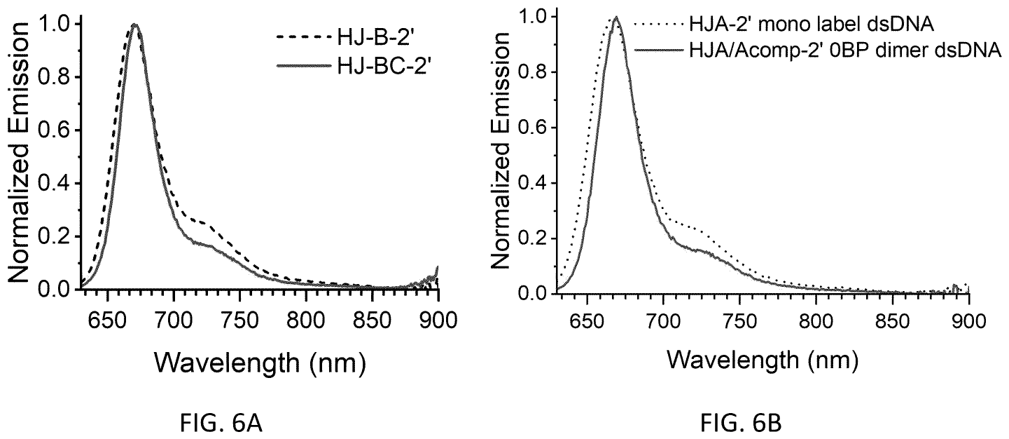

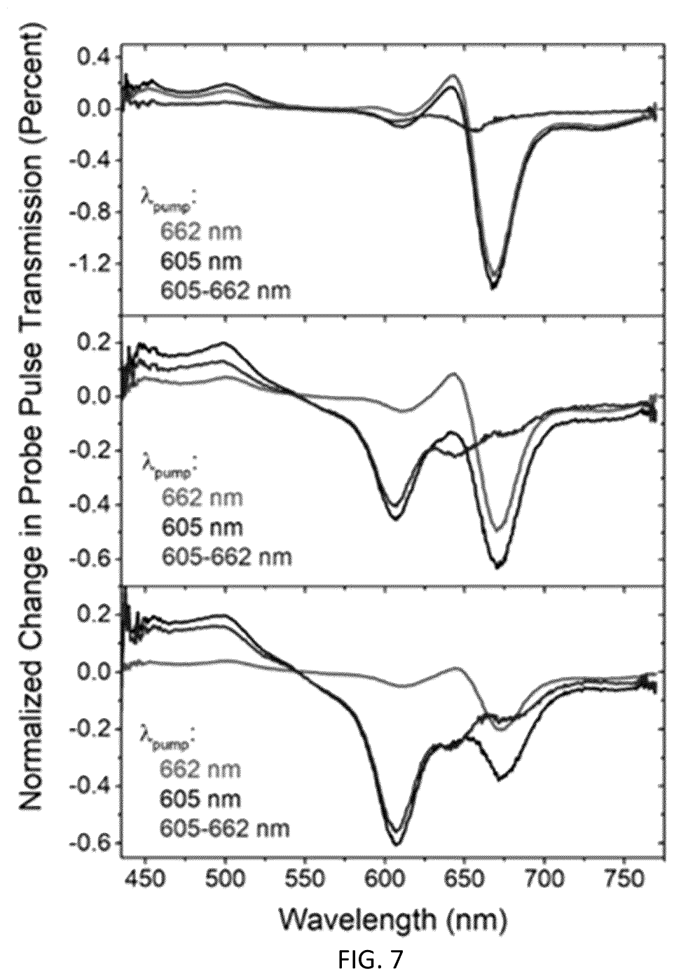

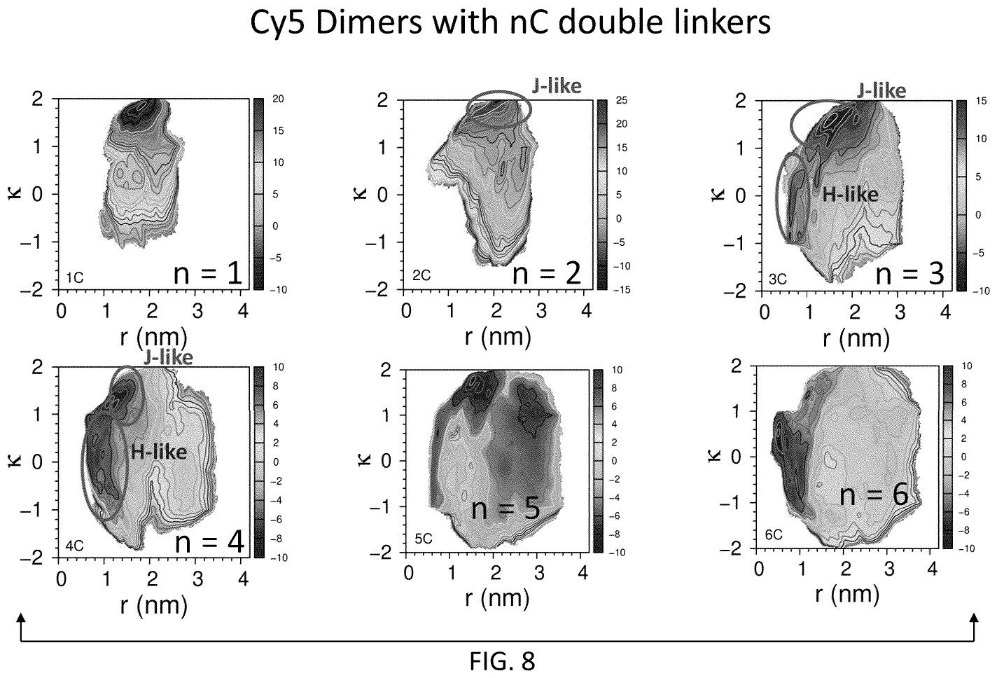

3. A method of preparing a phosphoramidite comprises a synthetic scheme as depicted in FIG. 1C.

4. The method of claim 3, wherein n=2 or 4.


SEQUENCE LISTING (5 sequences)

SEQ ID NO: 1 - DNA, 26 bp, synthetic construct
  source 1..26: mol_type = other DNA
  misc_feature 13..14: note = site of Cy5 analog incorporation
atataatcgctcgcatattatgactg

SEQ ID NO: 2 - DNA, 26 bp, synthetic construct
  source 1..26: mol_type = other DNA
  misc_feature 13..14: note = site of Cy5 analog incorporation
cagtcataatatgtggaatgtgagtg

SEQ ID NO: 3 - DNA, 26 bp, synthetic construct
  source 1..26: mol_type = other DNA
  misc_feature 13..14: note = site of Cy5 analog incorporation
cactcacattccactcaacaccacaa

SEQ ID NO: 4 - RNA, 26 nt, synthetic construct
  source 1..26: mol_type = other RNA
  misc_feature 13..14: note = site of Cy5 analog incorporation
ttgtggtgttgagcgagcgattatat

SEQ ID NO: 5 - DNA, 26 bp, synthetic construct
  source 1..26: mol_type = other DNA
  misc_feature 13..14: note = site of Cy5 analog incorporation
cagtcataatatgcgagcgattatat